(19) United States
(12) Patent Application Publication
(10) Pub. No.: US 2014/0292539 A1
(43) Pub. Date: Oct. 2, 2014

(54) PRESENTATION METHOD, SERVICE PROVIDING METHOD, EFFECTIVENESS MEASURING APPARATUS, PRESENTATION APPARATUS AND SERVICE PROVIDING APPARATUS

(71) Applicants: TRANSTRON INC., Yokohama-shi (JP); FUJITSU LIMITED, Kawasaki-shi (JP)

(72) Inventors: Kiyohide Omiya, Kawasaki (JP); Takashi Shimada, Shinagawa (JP); Tsutomu Ohta, Kawasaki (JP); Hironobu Hase, Kawasaki (JP); Tomoyuki Tsuda, Yokohama (JP); Masayoshi Hoshiya, Yokohama (JP)

(73) Assignees: TRANSTRON INC., Yokohama-shi (JP); FUJITSU LIMITED, Kawasaki-shi (JP)

(21) Appl. No.: 14/226,069

(22) Filed: Mar. 26, 2014

(30) Foreign Application Priority Data
Mar. 29, 2013 (JP) 2013-075233

(51) Int. Cl. G08G 1/0967

(52) U.S. Cl. CPC G08G 1/0967
USPC 340/905

(57) ABSTRACT

An information providing apparatus includes a unit that presents an effectiveness of introducing a service of informing a driver during driving of information related to a point where hard braking is apt to happen, by comparing driving data when the service is provided and driving data when the service is not provided, and outputting a comparison result.

### CROSS-REFERENCE TO RELATED APPLICATION(S)

This application is based upon and claims the benefit of priority of the prior Japanese Patent Application No. 2013-075233, filed on Mar. 29, 2013, the entire contents of which are incorporated herein by reference.

### FIELD

The embodiments discussed herein are related to a presentation method, a service providing method, an effectiveness measuring apparatus, a presentation apparatus, and a service providing apparatus.

### BACKGROUND

An alerting system is available. The alerting system issues an alarm to a driver driving a vehicle when the vehicle runs in an accident-prone area. For example, in this alerting system, a server stores information about accident-prone areas in advance. The server receives, from onboard devices that are mounted on each of vehicles, location information of the vehicles. The server then determines whether there is any vehicle traveling in an accident-prone area, using the information about accident-prone areas and the received location information of the vehicles. When there is a vehicle traveling in an accident-prone area, the server makes the onboard device mounted on the vehicle to issue an alarm. The function of this alerting system is introduced, for example, by a company as an alerting service to prevent an accident of a vehicle of the company. Examples of the onboard device include a digital tachograph, a car navigation system, and the like.

Moreover, for example, an apparatus that detects and stores, as a consequence of issuing an alarm, changes in a driving state of a vehicle for which the alarm has been issued, associating with information of the issued alarm is available. The stored information of the alarm is used to change a driving state of the vehicle when an alarm is issued in future. With regard to the related technologies, see International Publication Pamphlet No. WO2008/038375 and Japanese Laid-open Patent Publication No. 2004-78320, for example.

However, there is a problem that even if the alerting service is introduced, it is unable to ascertain the effectiveness of the introduced alerting service. For example, even if one company introduces an alerting service, behavior of a vehicle in an accident-prone area is not grasped by the introduced alerting service, and changes in behavior by the introduction of the alerting service are not evaluated on company basis. Furthermore, behavior of a vehicle in an accident-prone area is not grasped, and changes in behavior by the introduction of the alerting service are not evaluated for each driver.

### SUMMARY

According to an aspect of an embodiment, a non-transitory computer-readable recording medium has stored therein an effectiveness measuring program that causes a computer to execute a process. The process includes performing comparison between first driving data and second driving data, the first driving data acquired when an alarm is issued for a driver driving at certain point on a road, and the second driving data acquired when the alarm is not issued for the driver driving thereon, and outputting a comparison result.

According to another aspect of an embodiment, a presentation method includes presenting an effectiveness of introducing a service of informing a driver during driving of information related to a point where hard braking is apt to happen, by comparing driving data when the service is provided and driving data when the service is not provided, and outputting a comparison result.

According to still another aspect of an embodiment, a service providing method is associated with a service of informing a driver currently driving of information related to a point where hard braking is apt to happen, according to a start request of the service. The method includes: identifying driving data that is collected before start of the service in response to a request of the start of the service; comparing the driving data identified in the identifying and driving data that is collected after the request of the start of the service; and outputting variations in a driving state before and after the start of the service.

According to still another aspect of an embodiment, a service providing method is associated with a service of informing a driver currently driving of information related to a point where hard braking is apt to happen, according to a start request of the service. The method includes: updating sequentially the point where hard braking is apt to happen; informing about the point to the driver driving at a position corresponding to the point updated sequentially; performing comparison among driving data that are collected at different points of time after start of the service; and outputting variations in a driving state influenced by changes in the point by the updating.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of an information providing apparatus according to a first embodiment;

FIG. 2 illustrates an example of an information providing apparatus according to a second embodiment;

FIG. 3 depicts an example of a data configuration of a digi-tacho data;

FIG. 4 depicts an example of a data configuration of operation information;

FIG. 5 depicts an example of a data configuration of hard braking information;

FIG. 6 depicts an example of a data configuration of accident-prone area information;

FIG. 7 depicts an example of a data configuration of an alerting history;

FIG. 8 is a diagram for explaining a number of hard braking events of each area in a before period;

FIG. 9 is a diagram for explaining a number of hard braking events of each area in the before period;

FIG. 10 is a diagram for explaining a number of hard braking events of each area in an after period;

FIG. 11 depicts an example of a comparison result based on the number of hard braking events;

FIG. 12 depicts an example of a comparison result based on the number of vehicles that have used hard braking;

FIG. 13 depicts an example of a comparison result based on the number of vehicles that have used hard braking;

FIG. 14 depicts an example of a comparison result based on the number of areas in which hard braking has occurred;

FIG. 15 depicts an example of a comparison result based on the number of areas in which hard braking has occurred;

FIG. 16 depicts an example of a comparison result based on the vehicle speed at hard braking events;

FIG. 17 depicts an example of a comparison result based on the number of hard braking events of each time frame;

FIG. 18 is a flowchart of a processing procedure of an information providing apparatus according to the second embodiment;

FIG. 19 is an explanatory diagram of an alerting area;

FIG. 20 is a diagram for explaining comparison based on variations in speed in an alerting area;

FIG. 21 depicts an example of a comparison result based on variations in speed in an alerting area;

FIG. 22 is a diagram for explaining comparison based on variations in speed in a predetermined range;

FIG. 23 depicts an example of a comparison result based on variations in speed in a predetermined range;

FIG. 24 is a diagram for explaining comparison based on variations in speed in a predetermined speed band;

FIG. 25 depicts an example of a comparison result based on variations in speed in a predetermined speed band;

FIG. 26 is a diagram for explaining comparison based on variations in speed before and after alerting;

FIG. 27 depicts an example of a comparison result based on variations in speed before and after alerting;

FIG. 28 is a flowchart of a processing procedure of an information providing apparatus according to a third embodiment;

FIG. 29 is a diagram for explaining comparison based on driving data according to a fourth embodiment; and

FIG. 30 illustrates a computer that executes an effectiveness measuring program.

### DESCRIPTION OF EMBODIMENTS

Preferred embodiments of the present invention will be explained with reference to accompanying drawings. The present invention is not limited to these embodiments. The respective embodiments can be combined as necessary without causing inconsistency in processing.

### [a] First Embodiment

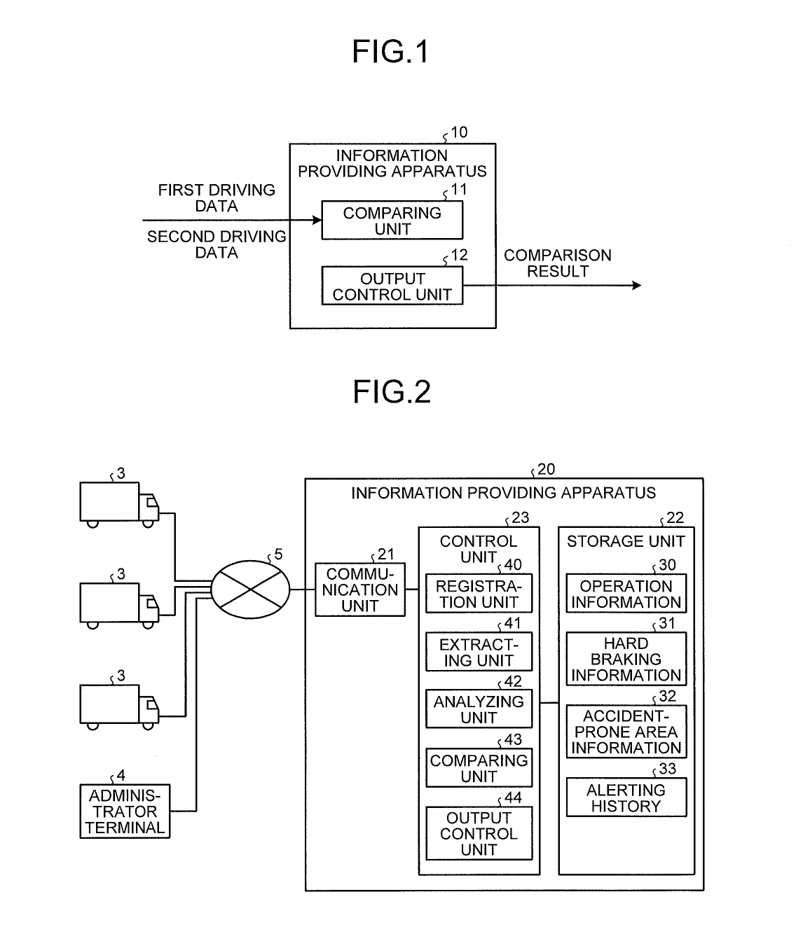

An information providing apparatus according to a first embodiment is explained. FIG. 1 illustrates an example of the information providing apparatus according to the first embodiment. As illustrated in FIG. 1, an information providing apparatus 10 includes a comparing unit 11, and an output control unit 12. The information providing apparatus 10 illustrated in FIG. 1 is to ascertain the effectiveness of introducing an alerting service, for example, when one company introduces the alerting service by an alerting system that is arranged independently of the information providing apparatus 10. Hereinafter, a vehicle operator may be described as “driver”. Moreover, the information providing apparatus 10 is one example of an effectiveness measuring apparatus.

An alerting system is explained herein. In this alerting system, for example, a server gives information about accident-prone areas to an onboard device that is mounted on each of vehicles. Each onboard device issues alarm when the vehicle travels in an accident-prone area using the given information and a position of the vehicle. With the function of this alerting system, an alerting service that issues an alarm for a driver of a vehicle that is traveling in an accident-prone area is introduced. Examples of the onboard device include a digital tachograph, a car navigation device, a mobile terminal such as a mobile phone and a smartphone, and the like. Furthermore, a digital tachograph may be described hereinafter as “digi-tacho”.

As described, the information providing apparatus 10 according to the first embodiment performs processing explained below to ascertain effectiveness of introducing the alerting service, for example, when the alerting service is introduced to one company.

The comparing unit 11 compares first driving data when alarm is issued for a driver driving in a certain point on a road and second driving data when the alarm is not issued for a driver driving therein.

For example, the comparing unit 11 collects speed data that indicates speed of a vehicle in an accident-prone area from each onboard device mounted on vehicles owned by one company. The comparing unit 11 then acquires the number of hard braking events when the alarm is issued and the number of hard braking events when the alarm is not issued in the accident-prone area using the acquired speed data. The comparing unit 11 then compares the number of hard braking events when the alarm is issued and the number of hard braking events when the alarm is not issued.

The output control unit 12 outputs a comparison result. For example, the output control unit 12 outputs a comparison result from comparison performed by the comparing unit 11 to a terminal device of an administrator that is operated by the administrator of the company.

As described, the information providing apparatus 10 according to the first embodiment compares the first driving data that is acquired when an alarm is issued at a certain point on a road for a driver driving thereon and the second driving data that is acquired when the alarm is not issued for a driver driving thereon, and outputs a comparison result. With this, the information providing apparatus 10 according to the first embodiment enables to ascertain the effectiveness of introducing the alerting service.

Although in the first embodiment, a case in which the onboard device issues an alarm using the position of the vehicle and the given information (information about areas) has been explained, it is not limited thereto, and a case in which the server is informed of the position of the vehicle, and the server determines the position and issues an alarm is also applicable. Moreover, although it has been explained that the information providing apparatus 10 is arranged separately from the alerting system, the function of the information providing apparatus 10 may be included in the alerting system. For example, the server of the alerting system may have the function of the information providing apparatus 10.

Furthermore, although in the first embodiment, a case in which the alerting service is introduced to one company has been explained, the example is not limiting. For example, the aforementioned techniques may be applied to a case in which an individual person uses the alerting service.

Moreover, although in the first embodiment, a case in which comparison is performed based on the number of hard braking events, the embodiment is not limiting. For example, comparison may be performed based on other behaviors of a vehicle such as abrupt acceleration and abrupt steering.

### [b] Second Embodiment

A second embodiment is explained. FIG. 2 illustrates an example of an information providing apparatus according to a second embodiment. As illustrated in FIG. 2, an information providing apparatus 20 includes a communication unit 21, a storage unit 22, and a control unit 23. Furthermore, the information providing apparatus 20, a vehicle 3, and an administrator terminal 4 are connected through a network 5 in a communication-enabled manner, and are enabled to communicate various kinds of information. A form of the network 5 may be any communication network such as a local area network (LAN) and a virtual private network (VPN) irrespective of wire or wireless. Although an example in which three units of the vehicles 3 are connected to the information providing apparatus 20 is illustrated in FIG. 2, the number of vehicles 3 is not limited thereto, and an arbitrary number of the vehicles 3 may be connected.

In the second embodiment, a case in which the alerting service is provided to a company A by the information providing apparatus 20 is explained. Specifically, the information providing apparatus 20 informs the vehicles 3 of a frequent hard-braking area at which hard braking frequently occurs. When the vehicle 3 travels in the frequent hard-braking area, a digi-tacho mounted on the vehicle 3 issues an alarm. The information providing apparatus 20 is an example of the effectiveness measuring apparatus.

The vehicle 3 is equipped with, for example, a digi-tacho. The digi-tacho generates digi-tacho data at predetermined time intervals, and transmits the generated digi-tacho data to the information providing apparatus 20. This digi-tacho data includes various kinds of information such as latitude, longitude, and speed of the vehicle. The predetermined time is, for example, one second.

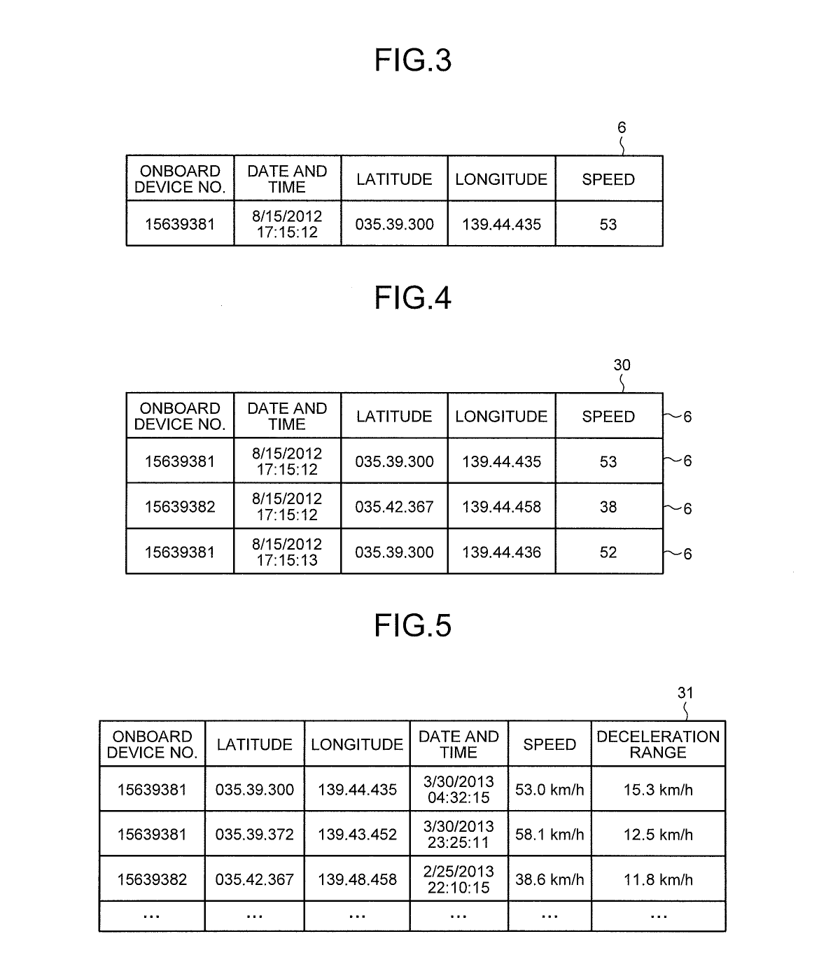

FIG. 3 depicts an example of a data configuration of the digi-tacho data. Digi-tacho data 6 in the example illustrated in FIG. 3 includes respective fields of “onboard device No.”, “date and time”, “latitude”, “longitude”, and “speed”. In the field of onboard device No., an identification number to identify a digi-tacho that transmits operation information is registered. In the field of date and time, date and time of generation of the operation information is registered. In the field of latitude, the latitude at which the vehicle 3 on which the digi-tacho identified by the number registered in the field of onboard device No. is mounted is located at the date and time registered in the field of date and time is registered. In the field of longitude, the longitude at which the vehicle 3 on which the digi-tacho identified by the number registered in the field of onboard device No. is mounted is located at the date and time registered in the field of date and time is registered. In the field of speed, the speed of the vehicle 3 on which the digi-tacho identified by the number registered in the field of onboard device No. is mounted at the date and time registered in the field of date and time is registered.

In the example illustrated in FIG. 3, it is indicated that the digi-tacho data 6 is generated by a digi-tacho “15639381” on Aug. 15, 2012 (“Aug. 15, 2012”) at 17 o'clock, 15 minutes and 12 seconds (“17:15:12”). Furthermore, the digi-tacho data 6 indicates that the latitude and the longitude of the vehicle 3 equipped with the digi-tacho “15639381” on “Aug. 15, 2012” at “17:15:12” are “035.39.300” and “139.44.435”, respectively. Moreover, the digi-tacho data 6 indicates that the speed of the vehicle 3 equipped with the digi-tacho “15639381” on “Aug. 15, 2012” at “17:15:12” is “53” kilometers/hour (km/h).

The administrator terminal 4 is a terminal of various kinds that is operated by an administrator, such as a personal computer (PC) and a tablet terminal. For example, the administrator terminal 4 includes an operation receiving unit such as a keyboard with which the administrator inputs operations, and a display unit that displays various kinds of images. When the operation receiving unit receives a read request for a comparison result from the administrator, the administrator terminal 4 sends the read request to the information providing apparatus 20 through the network 5. Furthermore, the administrator terminal 4 receives the comparison result transmitted from the information providing apparatus 20 through the network 5, and controls the display unit to display the received comparison result.

The information providing apparatus 20 compares the first driving data acquired when an alarm is issued for a driver driving at a certain point on a road and the second driving data acquired when an alarm is not issued for the driver currently driving, and outputs a comparison result.

The communication unit 21 is an interface that controls communication with other devices. The communication unit 21 communicates various kinds of information with other devices through the network 5. For example, the communication unit 21 receives operation information transmitted from a digi-tacho mounted on the vehicle 3, and outputs the received operation information to the control unit 23 to be described later. Moreover, for example, the communication unit 21 receives a read request for a comparison result sent by the administrator terminal 4, and outputs the received read request to the control unit 23. Furthermore, for example, the communication unit 21 receives a comparison result output by an output control unit 44 to be described later, and transmits the received comparison result to the administrator terminal 4. As one form of the communication unit 21, a network interface card such as a LAN card may be used.

The storage unit 2 is a recording device such as a hard disk, a solid state drive (SSD), and an optical disc. The storage unit 22 may also be a rewritable semiconductor memory such as a random access memory (RAM), a flash memory, and a nonvolatile static random access memory (NVSRAM).

The storage unit 22 stores an operating system (OS) that is executed by the control unit 23 and various kinds of programs that are used for file management. For example, the storage unit 22 stores operation information 30, hard braking information 31, accident-prone area information 32, and alerting history 33.

The operation information 30 is data including the digi-tacho data 6. As an example, the operation information 30 is received from a digi-tacho mounted on the vehicle 3, and registered by a registration unit 40 to be described later. As another example, the operation information 30 is referred to by an extracting unit 41, an analyzing unit 42, and a comparing unit 43 to be described later.

FIG. 4 depicts an example of a data configuration of the operation information. As illustrated in FIG. 4, the operation information 30 is data including the digi-tacho data 6 that is generated by multiple dig-tachos. In the digi-tacho data 6, the digi-tacho data 6 of a predetermined period, for example, two years ago to present, is accumulated.

The hard braking information 31 is data including a point at which hard-braking has occurred. As an example, the hard braking information 31 is stored by the extracting unit 41 to be described later. As another example, the hard braking information 31 is referred to by the analyzing unit 42 to generate the accident-prone area information 32 to be described later.

FIG. 5 depicts an example of a data configuration of the hard braking information. As illustrated in FIG. 5, the hard braking information 31 includes various fields of “onboard device No.”, “latitude”, “longitude”, “date and time”, “speed”, and “deceleration range”. In the field of deceleration range, the speed decelerated within a predetermined time period by the vehicle 3 on which the digi-tacho identified by the number registered in the field of onboard device No. is mounted is registered. The predetermined time period is, for example one second.

In the example illustrated in FIG. 5, the hard braking information 31 indicates that the vehicle 3 equipped with the digi-tacho “15639381” used hard braking. Moreover, the hard braking information 31 indicates that the latitude and the longitude at which the vehicle 3 equipped with the digi-tacho “15639381” used hard braking are “035.39.300” and “139.44.435”, respectively. Furthermore, the hard braking information 31 indicates that date and time when the vehicle 3 equipped with the digi-tacho “15639381” used hard braking is “Mar. 30, 2013” at “4:32:15”. Moreover, the hard braking information 31 indicates that the speed of the vehicle 3 equipped with the digi-tacho “15639381” when used hard braking is “53” km/h, and the deceleration range is “15.3” km/h.

The accident-prone area information 32 is data including an area at which hard braking is apt to occur. As an example, the accident-prone area information 32 is generated by the analyzing unit 42. As another example, the accident-prone area information 32 is informed to the digi-tacho mounted on the vehicle 3 of the company that has introduced the alerting service.

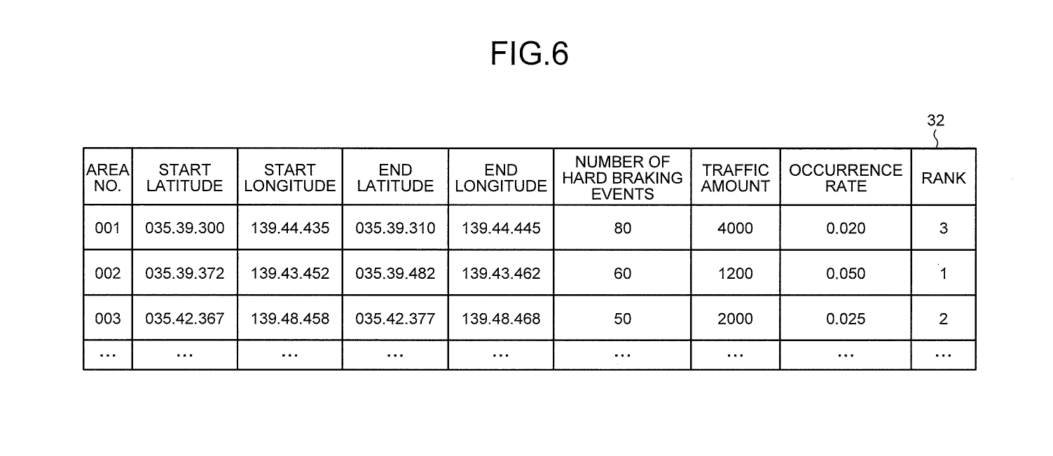

FIG. 6 depicts an example of a data configuration of the accident-prone area information. As illustrated in FIG. 6, the accident-prone area information 32 includes respective fields of “area No.”, “start latitude” “start longitude”, “end latitude”, “end longitude” “number of hard braking events”, “traffic amount”, “occurrence rate”, and “rank”. In the field of area No., an identification number to identify an area is registered. In the field of start latitude, the latitude of a starting point of an area that is identified by the number registered in the field of area No. is registered. In the field of start longitude, the longitude of a starting point of the area that is identified by the number registered in the field of area No. is registered. In the field of end latitude, the latitude of an ending point of the area that is identified by the number registered in the field of area No. is registered. In the field of end longitude, the longitude of an ending point of the area that is identified by the number registered in the field of area No. is registered. In the field of number of hard braking events, the number of hard braking that has occurred in the area that is identified by the number registered in the field of area No. is registered. In the field of traffic amount, the number of vehicles that have passed the area that is identified by the number registered in the field of area No. is registered. In the field of occurrence rate, the rate of occurrence of hard braking in the area that is identified by the number registered in the field of area No. is registered. In the field of rank, the rank in the occurrence rate registered in the field of occurrence rate is registered. The rank herein is given such that the higher occurrence rate is ranked higher.

In the example illustrated in FIG. 6, the accident-prone area information 32 indicates that the start latitude and the start longitude of an area that is identified by a number “001” are “035.39.300” and “139.44.435”, respectively. Moreover, the accident-prone area information 32 indicates that the end latitude and the end longitude of the area that is identified by the number “001” are “035.39.310” and “139.44.445”, respectively. Furthermore, the accident-prone area information 32 indicates that hard braking occurred “80” times and “4000” units of the vehicles 3 passed in the area that is identified by the number “001”. Moreover, the accident-prone area information 32 indicates that the rate of occurrence of hard braking is “0.020” in the area that is identified by the number “001” and the rank is “3”.

The alerting history 33 is data that includes a history of informing the company that has introduced the alerting service of the accident-prone area information 32 for which alarm is issued by the alerting service. As an example, the alerting history 33 is recorded by the control unit 23 when the accident-prone area information 32 is informed to a digi-tacho on the vehicle 3 of the company that has introduced the alerting service. As another example, the alerting history 33 is referred to by the comparing unit 43.

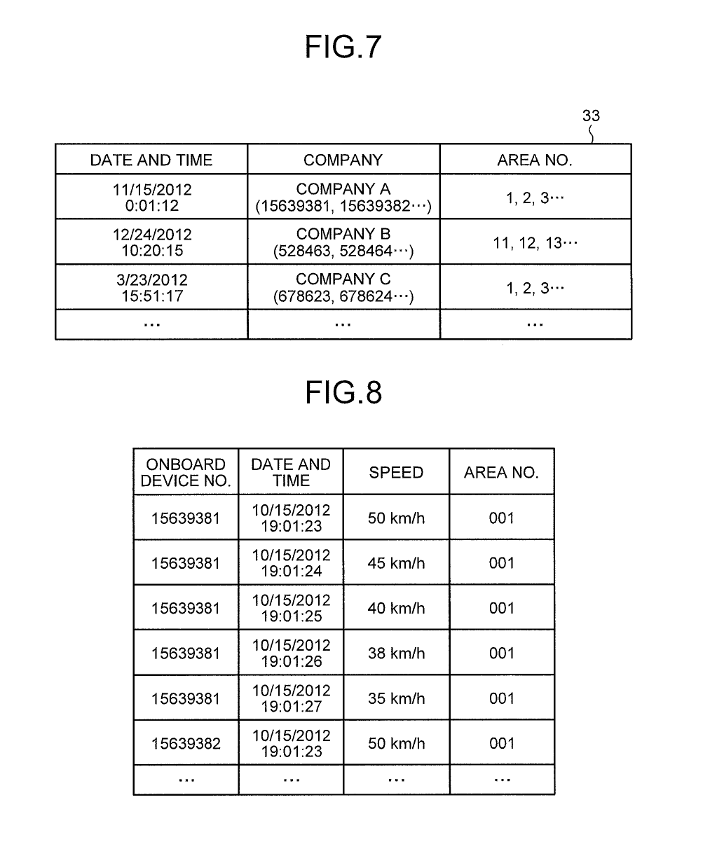

FIG. 7 depicts an example of a data configuration of the alerting history. As illustrated in FIG. 7, the alerting history 33 includes respective fields of “date and time”, “company”, and “area No.” In the example illustrated in FIG. 7, the alerting history 33 indicates that the accident-prone area information 32 was informed to the digi-tacho on the vehicle 3 of the “company A” on “Nov. 15, 2012” at “0:01:12”. Moreover, the alerting history 33 indicates that the onboard device No. of digi-tachos on the vehicles 3 of the company A to which the accident-prone area information 32 was informed are “15639381, 15639382, . . . .” Furthermore, the alerting history 33 indicates that the accident-prone area information 32 informed to the digi-tacho on the vehicle 3 of the company A is of area Nos. “1, 2, 3, . . . .”

The “date and time” recorded in the alerting history 33 corresponds to date and time at which one company introduces the alerting service. That is, in the example illustrated in FIG. 7, the alerting history 33 indicates that the date and time at which the company A introduced the alerting service is Nov. 15, 2012 0:01:12.

Referring back to FIG. 2, the control unit 23 is a device that controls the information providing apparatus 20. For the control unit 23, an electrical circuit such as a central processing unit (CPU) and a micro processing unit (MPU), or an integrated circuit such as an application specific integrated circuit (ASIC) and a field programmable gate array (FPGA) can be adopted. The control unit 23 has an internal memory to store a program and control data that prescribe various kinds of processing, and performs various kinds of processing therewith. The operation of various kinds of programs enables the control unit 23 to function as various kinds of processing units. For example, the control unit 23 includes the registration unit 40, the extracting unit 41, the analyzing unit 42, the comparing unit 43, and the output control unit 44.

The registration unit 40 registers various kinds of information in the storage unit 22. For example, each time the registration unit 40 receives the digi-tacho data 6 output from the communication unit 21, the registration unit 40 registers the digi-tacho data 6 as the operation information 30.

The extracting unit 41 extracts various kinds of information. For example, the extracting unit 41 extracts the digi-tacho data 6 of the moment when there was a hard braking from the operation information 30. The extracting unit 41 then stores the extracted digi-tacho data 6 as the hard braking information 31.

As an example, the extracting unit 41 acquires the digi-tacho data 6 of the past one year to the present time out of all of the digi-tacho data 6 in the operation information 30. Subsequently, the extracting unit 41 determines whether a piece of the digi-tacho data 6 that has not been selected is present among the acquired pieces of the digi-tacho data 6.

When a piece of the digi-tacho data 6 that has not been selected is present, the extracting unit 41 selects one piece of the digi-tacho data 6 that has not been selected. The extracting unit 41 then acquires the onboard device No., the date and time, the latitude, the longitude, and the speed included in the selected digi-tacho data 6. For example, when the digi-tacho data 6 that is registered as the first record is selected from the operation information 30 illustrated in FIG. 4, the extracting unit 41 performs following processing. That is, the extracting unit 41 acquires the onboard device No. “15639381”, the date and time “Aug. 15, 2012 17:15:12”, the latitude “035.39.300”, the longitude “139.44.435”, and the speed “53” km/h. The speed thus acquired may be expressed as “S1”.

Subsequently, the extracting unit 41 refers to the operation information 30, and identifies a piece of the digi-tacho data 6 that corresponds to that of one second prior to the selected digi-tacho data 6. For example, when the onboard device No. and the date and time of the selected digi-tacho data 6 are “15639381” and “Aug. 15, 2012 17:15:12”, respectively, the extracting unit 41 performs the following processing. That is, the extracting unit 41 refers to the operation information 30, to identify the digi-tacho data 6 the onboard device No. of which is “15639381” and the date and time of which is “Aug. 15, 2012 17:15:12”. The extracting unit 41 then acquires the speed included in the identified digi-tacho data 6. The speed thus acquired may be expressed as “S2”.

Subsequently, the extracting unit 41 determines whether a value (S2−S1) acquired by subtracting the speed S1 from the speed S2 is equal to or larger than a predetermined value, for example, 10 (km/h). When (S2−S1) is equal to or larger than the predetermined value, the extracting unit 41 performs the following processing. That is, the extracting unit 41 stores, in the hard braking information 31, the value (S2−S1) as a deceleration range associating with the selected digi-tacho data 6. For example, when the deceleration range is “15.3” km/h, the extracting unit 41 stores, in the hard braking information 31, the deceleration range “15.3” km/h associating with the onboard device No., the latitude, the longitude, the date and time, and the speed in the selected digi-tacho data 6.

The extracting unit 41 performs again the above described processing of determining whether a piece of the digi-tacho data 6 that has not been selected is present among the acquired pieces of the digi-tacho data 6. In addition, when (S2−S1) is not equal to or larger than the predetermined value also, the extracting unit 41 performs again the above described processing of determining whether a piece of the digi-tacho data 6 that has not been selected is present among the acquired pieces of the digi-tacho data 6. When a piece of the digi-tacho data 6 that has not been selected is present, the extracting unit 41 performs the above described processing of selecting a piece of the digi-tacho data 6 that has not been selected. The extracting unit 41 repeats the above processing at each selection of a piece of the digi-tacho data 6 that has not been selected. Thus, the extracting unit 41 stores information on hard braking of past one year to the present time in the storage unit 22 as the hard braking information 31.

The analyzing unit 42 analyzes various kinds of information. For example, the analyzing unit 42 generates the accident-prone area information 32 using the hard braking information 31 that is extracted by the extracting unit 41. The analyzing unit 42 then stores the generated accident-prone area information 32 in the storage unit 22.

The analyzing unit 42 refers to the hard braking information 31 and identifies an area in which hard braking happens a predetermined times or more within a predetermined range, as a frequent hard-braking area. The analyzing unit 42 determines a smallest value among latitudes of points at which hard braking has occurred included in the identified area as the “start latitude”. Moreover, the analyzing unit 42 determines a smallest value among longitudes of the points at which hard braking has occurred included in the identified area as the “start longitude”. Furthermore, the analyzing unit 42 determines a largest value among the latitudes of the points at which hard braking has occurred included in the identified area as the “end latitude”. Moreover, the analyzing unit 42 determines a largest value among the longitudes of the points at which hard braking has occurred included in the identified area as the “end longitude”. The analyzing unit 42 then generates an “area No.” to distinguish the identified area, to store in the storage unit 22 as the accident-prone area information 32 associating with the “start latitude”, the “start longitude”, the “end latitude”, the “end longitude”, and the “number of hard braking events”.

For example, the analyzing unit 42 identifies an area in which hard braking has occurred 20 times or more within a range of 100 square meters. When the analyzing unit 42 identifies an area in which hard braking has occurred “80” times as a result of this, the analyzing unit 42 performs the following processing. That is, the analyzing unit 42 determines the smallest value “035.39.300” among latitudes of 80 points included in the identified area, as the “start latitude”. Moreover, the analyzing unit 42 determines the smallest value “139.44.435” among longitudes of 80 points included in the identified area, as the “start longitude”. Furthermore, the analyzing unit 42 determines the largest value “035.39.310” among latitudes of 80 points included in the identified area, as the “end latitude”. Moreover, the analyzing unit 42 determines the largest value “139.44.445” among longitudes of 80 points included in the identified area, as the “end longitude”. The analyzing unit 42 then generates the area No. “001” to distinguish the identified area. Subsequently, the analyzing unit 42 stores the area No. “001”, the start latitude “035.39.300”, the start longitude “139.44.435”, the end latitude “035.39.310”, the end longitude “139.44.445”, and the number of hard braking events “80” associating with each other in the storage unit 22. At this point, nothing has been registered in the fields of “traffic amount”, “occurrence rate”, and “rank”.

As described, the analyzing unit 42 repeats the processing of referring to the hard braking information 31, and identifying a frequent hard-braking area described above until no area in which hard braking has been occurred a predetermined time or more within a predetermined range is left unprocessed. Thus, the analyzing unit 42 identifies frequent hard-braking areas from the hard braking information 31.

Subsequently, the analyzing unit 42 calculates the “traffic amount” of the identified frequent hard-braking area, and registers the calculated “traffic amount” in the accident-prone area information 32. For example, the analyzing unit 42 refers to the accident-prone area information 32 and acquires the start latitude “035.39.300”, the start longitude “139.44.435”, the end latitude “035.39.310”, the end longitude “139.44.445” that correspond to the area No. “001”. The analyzing unit 42 then refers to the operation information 30, and identifies pieces of the digi-tacho data 6 that are included in the area of the area No. “001”. By counting the identified pieces of the digi-tacho data 6, the analyzing unit 42 calculates, for example, the traffic amount “4000”. The analyzing unit 42 registers the calculated traffic amount “4000” in the accident-prone area information 32. The analyzing unit 42 calculates the “traffic amount” in a similar manner for other pieces of the frequent hard-braking areas, and registers the calculated “traffic amount” in the accident-prone area information 32. At a point of registration of the traffic amount, nothing has been registered in the fields of “occurrence rate” and “rank”.

Subsequently, the analyzing unit 42 calculates the “occurrence rate” of the identified frequent hard-braking area, and registers the calculated “occurrence rate” in the frequent hard-braking accident-prone area information 32. For example, when the “traffic amount” is registered for all records of the accident-prone area information 32, the analyzing unit 42 acquires the number of hard braking events “80” and the traffic amount “4000”. The analyzing unit 42 then calculates a value obtained by dividing the acquired number of hard braking events by the acquired traffic amount as the occurrence rate (number of hard braking events/traffic amount) of hard braking. For example, when the number of hard braking events “80” and the traffic amount “4000” are acquired, the analyzing unit 42 acquires the occurrence rate “0.020 (80/4000)” by calculation. Subsequently, the analyzing unit 42 registers the calculated occurrence rate in the field of “occurrence rate” of the corresponding record. For example, when the occurrence rate “0.020” is acquired by calculation, the analyzing unit 42 registers “0.020” in the field of the “occurrence rate” of the first record in the accident-prone area information 32 illustrated in FIG. 6. The analyzing unit 42 calculates the “occurrence rate” for other frequent hard-braking areas in a similar manner, and registers the calculated “occurrence rate” in the accident-prone area information 32. At the point of registration of the occurrence rate, nothing has been registered in the field of “rank” in the accident-prone area information 32.

Subsequently, when the “occurrence rate” has been registered for all records of the accident-prone area information 32, the analyzing unit 42 registers a rank in the field of “rank” in the accident-prone area information 32 such that the higher occurrence rate that is registered in the field of “occurrence rate” is ranked higher. For example, the analyzing unit 42 registers a rank in the field of “rank” in the accident-prone area information 32 as illustrated in FIG. 8.

When the analyzing unit 42 detects abrupt acceleration besides hard braking, calculation of the occurrence rate of abrupt acceleration may be performed similarly to the calculation of the occurrence rate of hard braking. That is, the analyzing unit 42 calculates the occurrence rate of abrupt acceleration (frequency of abrupt acceleration/traffic amount) obtained by dividing the acquired frequency of abrupt acceleration by the acquired traffic amount. As for the field of “occurrence rate”, each of the occurrence rate of hard braking and the occurrence rate of abrupt acceleration may be registered therein. The analyzing unit 42 may register ranks in the field of “rank” such that the higher occurrence rate of abrupt acceleration is ranked higher, separately from the ranks of the occurrence of hard braking. Furthermore, hard braking and abrupt acceleration can be considered hazardous events. Therefore, it is possible that the occurrence rate of hazardous event is calculated by dividing the number obtained by adding the number of hard braking events and the frequency of abrupt acceleration by the number of vehicles, and this occurrence rate of hazardous event is registered in the field of “occurrence rate”. In this case, the analyzing unit 42 registers ranks in the field of “rank” in the accident-prone area information 32 such that the higher occurrence rate of hazardous event that is registered in the field of “occurrence rate” is ranked higher.

As described, the accident-prone area information 32 is generated by the analyzing unit 42 described above. Thus, the accident-prone area information 32 is informed to a digi-tacho that is mounted on each of the vehicles 3 of the company that has introduced the alerting service, to provide the alerting service. In the disclosed techniques, processing respectively performed by the comparing unit 43 and the output control unit 44 explained below is performed to ascertain the effectiveness of introducing the alerting service.

The comparing unit 43 compares the first driving data when alarm is issued for a driver driving at a certain point on a road and the second driving data when the alarm is not issued for a driver driving thereon. As an example, upon receiving a read request for a comparison result output from the communication unit 21, the comparing unit 43 compares the number of hard braking events when alerted and the number of hard braking events when not alerted. The analyzing unit 42 then outputs a comparison result to the output control unit 44.

The processing when the comparing unit 43 performs comparison based on the number of hard braking events is explained below. A case in which the company A ascertains the effectiveness of introducing the alerting service when the company A introduces the alerting service is explained herein. In this example, the number of the vehicles 3 for which the company A introduces the alerting service is 90 units, and the number of the frequent hard-braking areas informed to the 90 units of the vehicles 3 is 800 areas. These 800 areas are, for example, areas mainly in Kanto region.

The comparing unit 43 refers to the alerting history 33, and identifies a period in which no alarm was issued and a period in which an alarm was issued. For example, the comparing unit 43 refers to the alerting history 33 illustrated in FIG. 7, and identifies the date and time “Nov. 15, 2012 0:01:12” corresponding to the “company A”. The comparing unit 43 then identifies a period before the identified date and time “Nov. 15, 2012 0:01:12” as a period in which no alarm was issued. Moreover, the comparing unit 43 identifies a period after the identified date and time “Nov. 15, 2012 0:01:12” as a period in which an alarm was issued.

Subsequently, the comparing unit 43 sets a “before period” that is a predetermined period to be a comparison object out of periods in which no alarm was issued, and an “after period” that is a predetermined period to be a comparison object out of periods in which an alarm was issued. The predetermined period is, for example, a month closest to the date and time of the oldest record among records recorded in the alerting history 33. For example, when a period before the date and time “Nov. 15, 2012 0:01:12” is identified as the period in which no alarm was issued, the comparing unit 43 sets a period “Oct. 1, 2012 to Oct. 31, 2012” that corresponds to a one-month period closest thereto as the before period. Moreover, for example, when a period after the date and time “Nov. 15, 2012 0:01:12” is identified as the period in which no alarm was issued, the comparing unit 43 sets a period “Dec. 1, 2012 to Dec. 31, 2012” that corresponds to a one-month period closest thereto as the after period. Although a case in which the comparing unit 43 sets the before period and the after period automatically has been explained, the disclosed techniques are not limited thereto. For example, the before period and the after period may be set to an arbitrary period by an administrator. Furthermore, the before period and the after period are not necessarily be the same period of time. For example, the after period may be two month period while the before period is one month period.

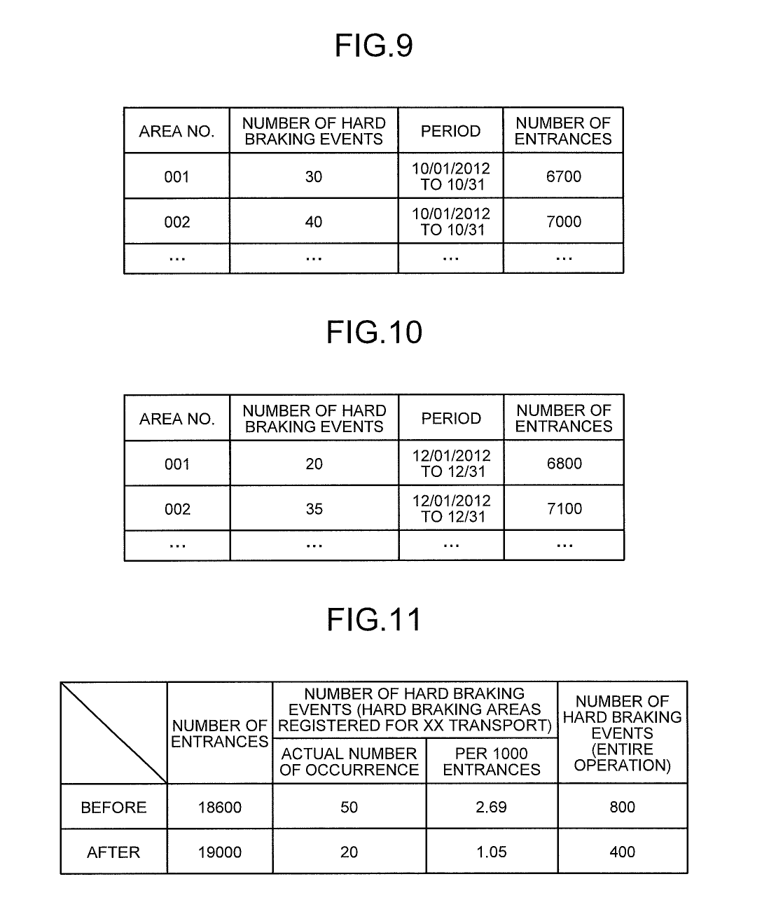

The comparing unit 43 then calculates the number of hard braking events of each area in the before period. FIG. 8 and FIG. 9 are diagrams for explaining the number of hard braking events of each area in the before period.

For example, the comparing unit 43 acquires, from the operation information 30, the digi-tacho data 6 of the vehicle 3 of the company A that has been informed of the accident-prone area information 32. In the example illustrated in FIG. 8, a case in which the comparing unit 43 acquires, from the operation information 30, the digi-tacho data 6 corresponding to when driving in the area of the area No. “001” in the before period “Oct. 1, 2012 to Oct. 31, 2012” is explained. Specifically, the comparing unit 43 acquires the digi-tacho data 6 the latitude of which is between the start latitude and the end latitude of the area No. “001”, and the longitude of which is between the start longitude and the end longitude of the area No. “001” from among all pieces of the digi-tacho data 6 in the operation information 30. For example, when the vehicle 3 in which a digi-tacho of the onboard device No. “15639381” was driving in the area of the area No. “001” on Oct. 15, 2012 at 19:01:23 at a speed of 50 km/h, the comparing unit 43 performs the following processing. The comparing unit 43 acquires the digi-tacho data 6 having the onboard device No. “15639381”, the date and time “Oct. 15, 2012 19:01:23”, and the speed “50 km/h” as in the first record in FIG. 8, from the operation information 30.

Subsequently, the comparing unit 43 calculates the number of entrances and the number of hard braking events of each area using the acquired digi-tacho data 6. For example, the comparing unit 43 selects the digi-tacho data 6 having successive date and time, and increments the “number of entrances” by 1. This is because the digi-tacho data 6 having successive date and time corresponds to a single entrance to the frequent hard-braking area. The comparing unit 43 determines whether hard braking was used in the selected record. When hard braking was used, the comparing unit 43 increments the “number of hard braking events” by 1. On the other hand, when hard braking was not used, the comparing unit 43 does not increment the “number of hard braking events”. The comparing unit 43 repeats the processing of selecting the digi-tacho data 6 having successive date and time until no piece of the digi-tacho data 6 that has not been selected remains, and thereby calculates the number of entrances and the number of hard braking events of each area.

In the example illustrated in FIG. 8, the comparing unit 43 selects five records from the first record to the fifth record. Thus, the comparing unit 43 increments the number of entrances to the area of the area No. “001” by 1. The comparing unit 43 then calculates the deceleration range of each second of the selected records, and when any of the calculated deceleration range is equal to or more than 10 (km/h), increments the number of hard braking events by 1. In the example illustrated in FIG. 8, the speed at Oct. 15, 2012 19:01:23 is “50” km/h and the speed at Oct. 15, 2012 19:01:24 is “45” km/h, and therefore, the comparing unit 43 calculates the deceleration range “5” km/h. Furthermore, because the speed at Oct. 15, 2012 19:01:24 is “45” km/h and the speed at Oct. 15, 2012 19:01:25 is “40” km/h, the comparing unit 43 calculates the deceleration range “5” km/h. Moreover, because the speed at Oct. 15, 2012 19:01:25 is “40” km/h and the speed at Oct. 15, 2012 19:01:26 is “38” km/h, the comparing unit 43 calculates the deceleration range “2” km/h. Furthermore, because the speed at Oct. 15, 2012 19:01:26 is “38” km/h and the speed at Oct. 15, 2012 19:01:27 is “35” km/h, the comparing unit 43 calculates the deceleration range “3” km/h. That is, the comparing unit 43 does not increment the number of hard braking events because any of the calculated deceleration range is not equal to or more than 10 (km/h). The comparing unit 43 repeats the processing of selecting the digi-tacho data 6 having successive date and time until no piece of the digi-tacho data 6 that has not been selected remains.

As described, the comparing unit 43 calculates the number of entrances and the number of hard braking events of each area in the before period. For example, as illustrated in FIG. 9, the comparing unit 43 calculates the number of hard braking events “30 and the number of entrances “6700” of the area of the area No. “001” in the before period. The comparing unit 43 calculates the number of entrances and the number of hard braking events of areas of other area Nos. similarly.

As described, the comparing unit 43 calculates the number of hard braking events of each area in the before period. For example, as illustrated in FIG. 9, the comparing unit 43 totalizes the number of hard braking events and the number of entrances for each of the 800 frequent hard-braking areas that are informed to the digi-tacho on the vehicle 3 of the company A in the before period.

Moreover, the comparing unit 43 calculates the number of hard braking events of each area in the after period. FIG. 10 is a diagram for explaining the number of hard braking events of each area in the after period.

For example, the comparing unit 43 acquires, from the operation information 30, the digi-tacho data 6 of the vehicle 3 of the company A that has been informed of the accident-prone area information 32 in the after period. Subsequently, the comparing unit 43 calculates the number of entrances and the number of hard braking events of each area using the acquired digi-tacho data 6. For example, as illustrated in FIG. 10, the comparing unit 43 calculates the number of hard braking events “20” and the number of entrances “6800” of the area No. “001” in the after period. The comparing unit 43 calculates the number of entrances and the number of hard braking events of areas of other area Nos. similarly. Because this processing is same as the processing of calculating the number of entrances and the number of hard braking events of each area in the before period, detailed explanation is omitted.

As described, the comparing unit 43 calculates the number of hard braking events of each area in the after period. For example, as illustrated in FIG. 10, the comparing unit 43 calculates the number of hard braking events and the number of entrances of each of the 800 frequent hard-braking areas that have been informed to the digi-tacho on the vehicle 3 of the company A in the after period. In the following, it is explained by exemplifying comparison results that are generated by the comparing unit 43.

### Comparison Result Example 1

A case in which the comparing unit 43 compares the number of hard braking events in the before period and the number of hard braking events in the after period is explained using FIG. 11. This is because it is assumed that number of hard braking events is to be less after the alerting service is introduced than before the alerting service is introduced. Furthermore, it is assumed that the number of hard braking events in the entire operation is to be less. FIG. 11 depicts an example of a comparison result based on the number of hard braking events.

For example, the comparing unit 43 totalizes the number of entrances of each area in the before period, and calculates the total number of entrances in the before period. In the example illustrated in FIG. 11, the comparing unit 43 totalizes the number of entrances of each area illustrated in FIG. 9 to acquire the number of entrances “18600” in the before period. Moreover, the comparing unit 43 totalizes the number of hard braking events of each area in the before period, to acquire the total number of hard braking events in the before period. In the example illustrated in FIG. 11, the comparing unit 43 totalizes the number of hard braking events of each area illustrated in FIG. 9 to acquire the number of hard braking events “50” in the before period. Furthermore, the comparing unit 43 calculates the number of hard braking events every 1000 entrances, based on the number of hard braking events in the before period and the number of entrances in the before period. In the example illustrated in FIG. 11, the comparing unit 43 calculates the number of hard braking events every 1000 entrances “2.69” based on the number of hard braking events “50” in the before period and the number of entrances “18600” in the before period. Furthermore, the comparing unit 43 calculates the number of hard braking events of the entire operation in the before period. In the example illustrated in FIG. 11, the comparing unit 43 refers to the hard braking information 31 illustrated in FIG. 5, and counts the number of hard braking events in the before period, and thereby calculates the number of hard braking events (entire operation) “800”.

Moreover, the comparing unit 43 totalizes the number of entrances of each area in the after period to acquire the total number of entrances in the after period. In the example illustrated in FIG. 11, the comparing unit 43 totalizes the number of entrances of each area illustrated in FIG. 10, and thereby calculates the number of entrances “19000” in the after period. Furthermore, the comparing unit 43 totalizes the number of hard braking events of each area in the after period to acquire the total number of hard braking events in the after period. In the example illustrated in FIG. 11, the comparing unit 43 totalizes the number of hard braking events of each area illustrated in FIG. 10, and thereby calculates the number of hard braking events “20” in the after period. Moreover, the comparing unit 43 calculates the number of hard braking events every 1000 entrances based on the number of hard braking events in the after period and the number of entrances in the after period. In the example illustrated in FIG. 11, the comparing unit 43 calculates the number of hard braking events every 1000 entrances in the after period “1.05” based on the number of hard braking events “20” in the after period and the number of entrances “19000” in the after period. Furthermore, the comparing unit 43 calculates the number of hard braking events of the entire operation in the after period. In the example illustrated in FIG. 11, the comparing unit 43 refers to the hard braking information 31 illustrated in FIG. 5 and counts the number of hard braking events in the after period, and thereby calculates the number of hard braking events (entire operation) “400”.

As described, the comparing unit 43 performs comparison between the number of hard braking events in the before period and the number of hard braking events in the after period by generating a comparison result as illustrated in FIG. 11. Specifically, according to the comparison result illustrated in FIG. 11, because the number of entrances in the before period and the number of entrances in the after period are approximately the same, it is assumed that the number of entrances does not vary according to times. Furthermore, according to the comparison result illustrated in FIG. 11, it is seen that the number of hard braking events every 1000 entrances is less in the after period than that in the before period. This indicates that the number of hard braking events in the frequent hard-braking area is reduced after introduction of the alerting service compared to before introduction of the alerting service. Moreover, according to the comparison result illustrated in FIG. 11, it is seen that the number of hard braking events in the entire operation is less in the after period than that in the before period. According to this, the comparing unit 43 can directly ascertain, based on the number of hard braking events, the effectiveness of introducing the alerting service that issues an alarm when driving in a frequent hard-braking area.

### Comparison Result Example 2

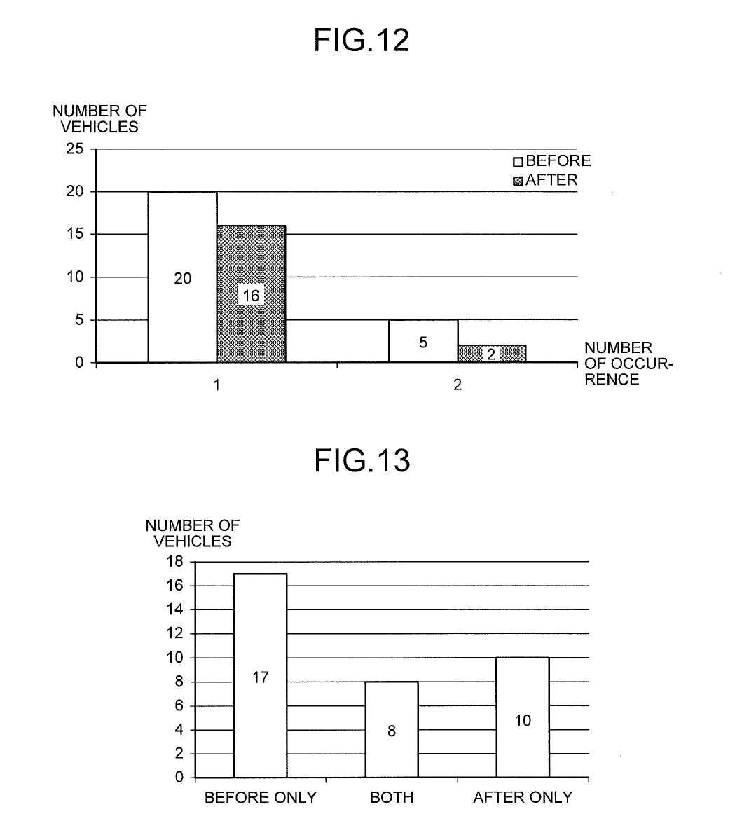

A case in which the comparing unit 43 compares the number of vehicles that have used hard braking in the before period and the number of vehicles that have used hard braking in the after period is explained using FIG. 12 and FIG. 13. This is because such a possibility is considered that the number of hard braking events disproportionately occurs in certain units of the vehicles 3. FIG. 12 and FIG. 13 depict examples of a comparison result based on the number of vehicles that have used hard braking.

The comparing unit 43 counts the number of hard braking events in the before period for each of the vehicles 3. For example, the comparing unit 43 acquires, from the operation information 30, the digi-tacho data 6 of the vehicle 3 of the company A that is informed of the accident-prone area information 32 in the before period. Subsequently, the comparing unit 43 selects pieces of the digi-tacho data 6 having successive date and times, from the acquired pieces of the digi-tacho data 6. The comparing unit 43 then determines whether hard braking has occurred in the selected record. When hard braking has occurred, the comparing unit 43 increments the “number of hard braking events” by 1, associating with the vehicle No. of the selected record. For example, when any of the deceleration ranges per second in the selected records is equal to or more than 10 (km/h) and when the vehicle No. corresponding to the selected record is “15639381”, the following processing is performed. That is, the comparing unit 43 increments the “number of hard braking events” by 1, associating with the vehicle No. “15639381”. Specifically, the comparing unit 43 counts the number of hard braking events for each unit of the vehicles 3 on which the digi-tacho corresponding to the vehicle No. is mounted. On the other hand, when hard braking was not used, the comparing unit 43 does not increment the “number of hard braking events”. The comparing unit 43 repeats the processing of selecting the digi-tacho data 6 having successive date and time from the acquired pieces of the digi-tacho data until no piece of the digi-tacho data 6 that has not been selected remains, and thereby calculates the number of hard braking events of each unit of the vehicles 3 in the before period.

Moreover, the comparing unit 43 counts the number of hard braking events in the after period for each unit of the vehicles 3. For example, the comparing unit 43 acquires, from the operation information 30, the digi-tacho data 6 of the vehicle 3 of the company A to which the accident-prone area information 32 has been informed in the after period. Subsequently, the comparing unit 43 selects pieces of the digi-tacho data 6 having successive date and times, from the acquired pieces of the digi-tacho data 6. The comparing unit 43 then determines whether hard braking has occurred in the selected record. When hard braking has occurred, the comparing unit 43 increments the “number of hard braking events” by 1, associating with the vehicle No. of the selected record. For example, when any of the deceleration ranges per second in the selected records is equal to or more than 10 (km/h) and when the vehicle No. corresponding to the selected record is “15639381”, the following processing is performed. That is, the comparing unit 43 increments the “number of hard braking events” by 1, associating with the vehicle No. “15639381”. Specifically, the comparing unit 43 counts the number of hard braking events for each unit of the vehicles 3 on which the digi-tacho corresponding to the vehicle No. is mounted. On the other hand, when hard braking has not occurred, the comparing unit 43 does not increment the “number of hard braking events”. The comparing unit 43 repeats the processing of selecting the digi-tacho data 6 having successive date and times from the acquired pieces of the digi-tacho data 6 until no piece of the digi-tacho data 6 that has not been selected remains, and thereby calculates the number of hard braking events of each unit of the vehicles 3 in the after period.

Subsequently, the comparing unit 43 counts the number of vehicles that have used hard braking, for each frequency of hard braking events. In FIG. 12, the horizontal direction corresponds to the number of hard braking events and the vertical direction corresponds to the number of vehicles that have used hard braking. In the example illustrated in FIG. 12, the comparing unit 43 counts the vehicles 3 that have used hard braking once in the before period, and acquires “20” units. Moreover, the comparing unit 43 counts the number of vehicles 3 that have used bard braking twice in the before period, and acquires “5” units. Furthermore, the comparing unit 43 counts the number of vehicles that have used hard braking once in the after period, and acquires “16” units. Moreover, the comparing unit 43 counts the number of vehicles 3 that have used bard braking twice in the after period, acquires “2” units.

Furthermore, as illustrated in FIG. 13, the comparing unit 43 counts the number of vehicles that have used hard braking according to the period after the introduction of the alerting service. In FIG. 13, the horizontal direction corresponds to periods in introduction of the alerting service, and indicates either a before period only, an after period only, or both periods of the before period and the after period. Moreover, the vertical direction corresponds to the number of vehicles that have used hard braking. In the example illustrated in FIG. 13, the comparing unit 43 counts the number of vehicles that have used hard braking in the before period only, and acquires “17” units. Furthermore, the comparing unit 43 counts the number of vehicles that have used hard braking in the after period only, and acquires “10” units. Moreover, the comparing unit 43 counts the number of vehicles that have used hard braking in both periods of the before period and the after period, and acquires “8” units.

As described, the comparing unit 43 performs comparison between the number of vehicle that have used hard braking in the before period and the number of vehicle that have used hard braking in the after period by generating a comparison result as illustrated in FIG. 12 and FIG. 13. That is, according to the comparison result illustrated in FIG. 12, it is understood that in the before period, hard braking has occurred disproportionately in five units of the vehicles 3. Furthermore, according to the comparison result illustrated in FIG. 12, it is understood that in the after period, hard braking has occurred disproportionately in two units of the vehicles 3.

Moreover, according to the comparison result illustrated in FIG. 13, it is understood that the alerting service is effective for the 17 units of vehicles that have used hard braking in the before period only. Furthermore, according to the comparison result illustrated in FIG. 13, it is understood that there is a room for further improvement for the 10 units of vehicles that have used hard braking in the after period only, and for the 8 units of vehicles that have used hard braking in both periods. According to this, the comparing unit 43 can verify hard braking that occurs disproportionately in certain units of the vehicles 3.

### Comparison Result Example 3

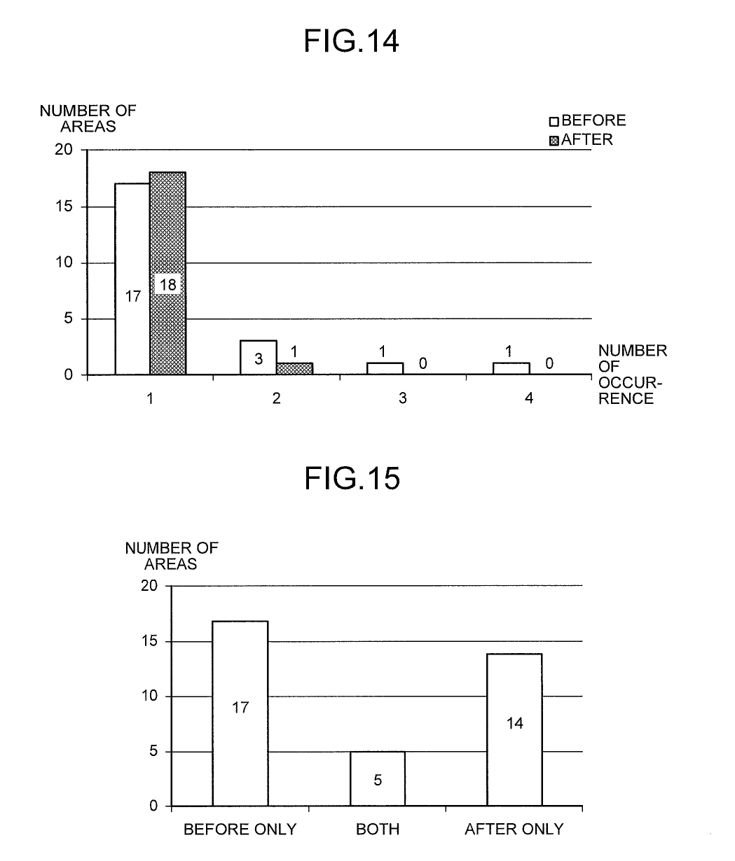

A case in which the comparing unit 43 compares the number of areas in which hard braking has occurred in the before period and the number of areas in which hard braking has occurred in the after period is explained using FIG. 14 and FIG. 15. This is because such a possibility is considered that hard braking events disproportionately occurs in certain areas in which hard braking has occurred. FIG. 14 and FIG. 15 depict an example of a comparison result based on the number of areas in which hard braking has occurred.

The comparing unit 43 counts the number of hard braking events in the before period for each of the areas in which hard braking has occurred. For example, the comparing unit 43 acquires, from the operation information 30, the digi-tacho data 6 of the vehicle 3 of the company A to which the accident-prone area information 32 has been informed in the before period. Subsequently, the comparing unit 43 selects the digi-tacho data 6 having successive date and times from the acquired digi-tacho data 6. The comparing unit 43 then determines whether hard braking was used in a selected record. When hard braking was used, the comparing unit 43 increments the “number of hard braking events” by 1, associating with the area No. of the frequent hard-braking area in which the selected record is included. For example, when any of the deceleration ranges per second in the selected records is equal to or more than 10 (km/h) and the latitude and the longitude corresponding to the selected record are “035.39.300” and “139.44.435”, respectively, the following processing is performed. That is, the comparing unit 43 increments the “number of hard braking events” by 1, associating with the area No. “001”. That is, the comparing unit 43 counts the number of hard braking events for each of the frequent hard-braking areas. On the other hand, when hard braking was not used, the comparing unit 43 does not increment the “number of hard braking events”. The comparing unit 43 repeats the processing of selecting the digi-tacho data 6 having successive date and times from the acquired pieces of the digi-tacho data until no piece of the digi-tacho data 6 that has not been selected remains, and thereby counts the number of hard braking events in the before period for each of the frequent hard-braking areas.

Furthermore, the comparing unit 43 counts the number of hard braking events in the after period for each of the areas in which hard braking has occurred. For example, the comparing unit 43 acquires, from the operation information 30, the digi-tacho data 6 of the vehicle 3 of the company A to which the accident-prone area information 32 has been informed in the after period. Subsequently, the comparing unit 43 selects the digi-tacho data 6 having successive date and times from the acquired digi-tacho data 6. The comparing unit 43 then determines whether hard braking was used in a selected record. When hard braking was used, the comparing unit 43 increments the “number of hard braking events” by 1, associating with the area No. of the frequent hard-braking area in which the selected record is included. For example, when any of the deceleration ranges per second in the selected records is equal to or more than 10 (km/h) and when the latitude and the longitude corresponding to the selected record are “035.39.300” and “139.44.435”, respectively, the following processing is performed. That is, because the selected record is included in the area of the area No. “001”, the comparing unit 43 increments the “number of hard braking events” by 1, associating with the area No. “001”. That is, the comparing unit 43 counts the number of hard braking events for each of the frequent hard-braking areas. On the other hand, when hard braking was not used, the comparing unit 43 does not increment the “number of hard braking events”. The comparing unit 43 repeats the processing of selecting the digi-tacho data 6 having successive date and times from the acquired pieces of the digi-tacho data until no piece of the digi-tacho data 6 that has not been selected remains, and thereby counts the number of hard braking events in the after period for each of the frequent hard-braking areas.

Subsequently, the comparing unit 43 counts the number of points at which hard braking occurred, for each frequency of hard braking events. In FIG. 14, the horizontal direction corresponds to the number of hard braking events and the vertical direction corresponds to the number of points at which hard braking occurred. In the example illustrated in FIG. 14, the comparing unit 43 counts the frequent hard-braking areas in which hard braking occurred once in the before period, and acquires “17” areas. Moreover, the comparing unit 43 counts the frequent hard-braking areas in which hard braking occurred twice in the before period, and acquires “3” areas. Furthermore, the comparing unit 43 counts the frequent hard-braking areas in which hard braking occurred three times in the before period, and acquires “1” area. Moreover, the comparing unit 43 counts the frequent hard-braking areas in which hard braking occurred four times in the before period, and acquires “1” area. Furthermore, the comparing unit 43 counts the frequent hard-braking areas in which hard braking occurred once in the after period, and acquires “18” areas. Moreover, the comparing unit 43 counts the frequent hard-braking areas in which hard braking occurred twice in the after period, and acquires “1” area. Furthermore, the comparing unit 43 counts the frequent hard-braking areas in which hard braking occurred three times in the after period, and acquires “0” areas. Moreover, the comparing unit 43 counts the frequent hard-braking areas in which hard braking occurred four times in the after period, and acquires “0” areas.

Furthermore, as illustrated in FIG. 15, the comparing unit 43 counts the number of the areas in which hard braking occurred for each period in introduction of the alerting service. In FIG. 15, the horizontal direction corresponds to periods in introduction of the alerting service, and indicates either a before period only, an after period only, or both periods of the before period and the after period. Moreover, the vertical direction corresponds to the number of areas in which hard braking occurred. In the example illustrated in FIG. 15, the comparing unit 43 counts the number of frequent hard-braking areas in which hard braking occurred in the before period only, and acquires “17” areas. Furthermore, the comparing unit 43 counts the number of frequent hard-braking areas in which hard braking occurred in the after period only, and acquires “14” areas. Moreover, the comparing unit 43 counts the number of frequent hard-braking areas in which hard braking occurred in both periods of the before period and the after period, and acquires “5” areas.

As described, the comparing unit 43 performs comparison between the number of frequent hard-braking areas in which hard braking occurred in the before period and the number of frequent hard-braking areas in which hard braking occurred in the after period by generating a comparison result as illustrated in FIG. 14 and FIG. 15. That is, according to the comparison result illustrated in FIG. 14, it is understood that in the before period, there are five areas in which hard braking disproportionately occurred twice or more times. Furthermore, according to the comparison result illustrated in FIG. 14, it is understood that in the after period, there is one area in which hard braking disproportionately occurred twice or more times. Moreover, according to the comparison result illustrated in FIG. 15, it is understood that the alerting service is effective for the 17 areas in which hard braking occurred in the before period only. Furthermore, according to the comparison result illustrated in FIG. 15, it is understood that there is a room for further improvement for the 14 areas in which hard braking occurred in the after period only, and for the 5 areas in which hard braking occurred in both periods. According to this, the comparing unit 43 can verify hard braking that occurs disproportionately in certain frequent hard-braking areas.

### Comparison Result Example 4

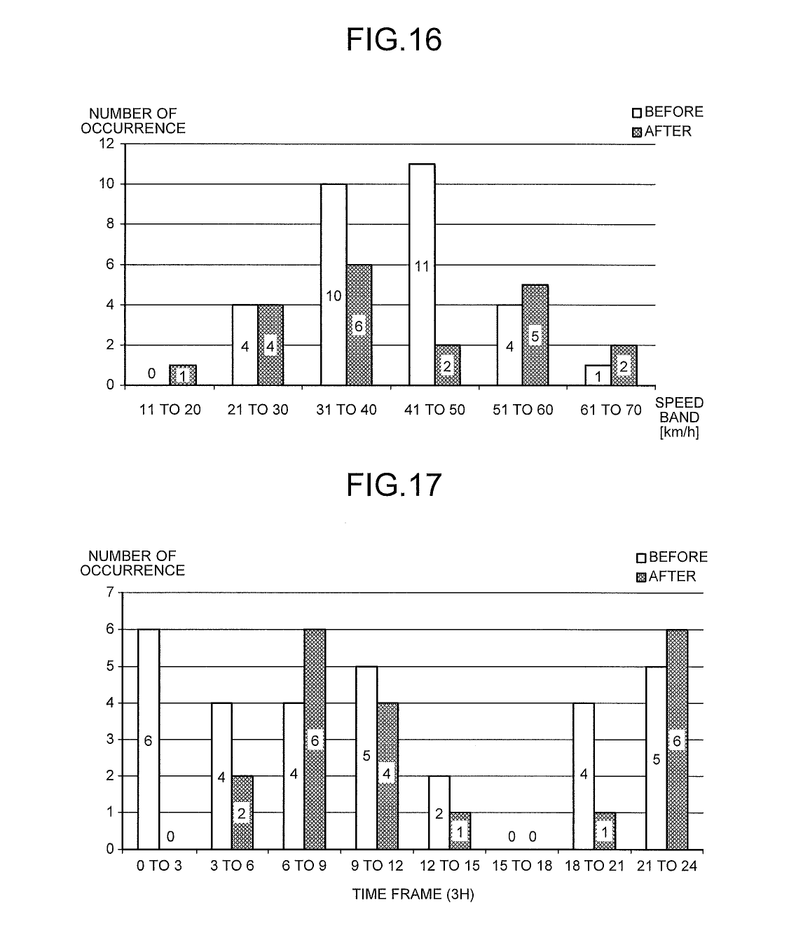

A case in which the comparing unit 43 compares the number of hard braking events in the before period and the number of hard braking events in the after period for each speed band is explained using FIG. 16. This is because such a possibility is considered that the effectiveness of introducing the alerting service varies according to speed bands. FIG. 16 depicts an example of a comparison result based on the vehicle speed at hard braking events.

The comparing unit 43 counts the number of hard braking events in the before period for each vehicle speed at hard braking events. The speed bands are, for example, speed bands of each 10 km/h including 11 km/h to 20 km/h, 21 km/h to 30 km/h, 31 km/h to 40 km/h, 41 km/h to 50 km/h, 51 km/h to 60 km/h, and 61 km/h to 70 km/h. For example, the comparing unit 43 acquires, from the operation information 30, the digi-tacho data 6 of the vehicle 3 of the company A that has been informed of the accident-prone area information 32 in the before period. Subsequently, the comparing unit 43 selects pieces of the digi-tacho data 6 having successive date and times, from the acquired pieces of the digi-tacho data 6. The comparing unit 43 then determines whether hard braking was used in the selected record. When hard braking occurred, the comparing unit 43 increments the “number of hard braking events” by 1, associating with the speed of the selected record. For example, when any of the deceleration ranges per second in the selected record is equal to or more than 10 (km/h) and when the speed corresponding to the selected record is “53 km/h”, the following processing is performed. That is, the comparing unit 43 increments the “number of hard braking events” by 1, associating with the speed band of 51 km/h to 60 km/h. That is, the comparing unit 43 counts the number of hard braking events for each speed at hard braking events. On the other hand, when hard braking was not used, the comparing unit 43 does not increment the “number of hard braking events”. The comparing unit 43 repeats the processing of selecting the digi-tacho data 6 having successive date and times from the acquired pieces of the digi-tacho data 6 until no piece of the digi-tacho data 6 that has not been selected remains, and thereby counts the number of hard braking events in the before period for each speed at hard braking events.

Moreover, the comparing unit 43 counts the number of hard braking events in the after period for each vehicle speed at hard braking events. For example, the comparing unit 43 acquires, from the operation information 30, the digi-tacho data 6 of the vehicle 3 of the company A that has been informed of the accident-prone area information 32. Subsequently, the comparing unit 43 selects pieces of the digi-tacho data 6 having successive date and times, from the acquired pieces of the digi-tacho data 6. The comparing unit 43 then determines whether hard braking was used in the selected record. When hard braking was used, the comparing unit 43 increments the “number of hard braking events” by 1, associating with the speed of the selected record. For example, when any of the deceleration ranges per second in the selected records is equal to or more than 10 (km/h) and when the speed corresponding to the selected record is “42 km/h”, the following processing is performed. That is, the comparing unit 43 increments the “number of hard braking events” by 1, associating with the speed band of 41 km/h to 50 km/h. That is, the comparing unit 43 counts the number of hard braking events for each speed at hard braking events. On the other hand, when hard braking was not used, the comparing unit 43 does not increment the “number of hard braking events”. The comparing unit 43 repeats the processing of selecting the digi-tacho data 6 having successive date and times from the acquired pieces of the digi-tacho data 6 until no piece of the digi-tacho data 6 that has not been selected remains, and thereby counts the number of hard braking events in the after period for each speed at hard braking events.

Subsequently, the comparing unit 43 counts the number of points at which hard braking occurred, for each of the speed bands. In FIG. 16, the horizontal direction corresponds to the speed band of each 10 km/h and the vertical direction corresponds to the number hard braking events. In the example illustrated in FIG. 16, the comparing unit 43 counts hard braking occurred in the speed band of 11 km/h to 20 km/h in the before period, and acquires “0” times. Moreover, the comparing unit 43 counts the number of hard braking that occurred in each of the speed bands, 21 km/h to 30 km/h, 31 km/h to 40 km/h, 41 km/h to 50 km/h, 51 km/h to 60 km/h, and 61 km/h to 70 km/h in the before period. Furthermore, the comparing unit 43 counts hard braking that occurred in the speed band of 11 km/h to 20 km/h in the after period, and acquires “1” time. Moreover, the comparing unit 43 counts the number of hard braking that occurred in each of the speed bands, 21 km/h to 30 km/h, 31 km/h to 40 km/h, 41 km/h to 50 km/h, 51 km/h to 60 km/h, and 61 km/h to 70 km/h in the after period.

As described, the comparing unit 43 performs comparison between the number of hard braking events in the before period and the number of hard braking events in the after period for each speed band by generating a comparison result as illustrated in FIG. 16. That is, according to the comparison result illustrated in FIG. 16, it is understood that the number of hard braking events has decreased by the introduction of the alerting service especially in the speed bands of 31 km/h to 40 km/h and 41 km/h to 50 km/h. According to this, the comparing unit 43 can verify the effectiveness of introducing the alerting service according to speed bands.

### Comparison Result Example 5

A case in which the comparing unit 43 performs comparison between the number of hard braking events in the before period and the number of hard braking events in the after period for each time frame is explained using FIG. 17. This is because such a possibility is considered that the effectiveness of introducing the alerting service varies according to time frames. FIG. 17 depicts an example of a comparison result based on the number of hard braking events of each time frame.

The comparing unit 43 counts the number of hard braking event in the before period for each time frame. The time frames are, for example, time frames of each three hours, 0 o'clock to 3 o'clock, 3 o'clock to 6 o'clock, 6 o'clock to 9 o'clock, 9 o'clock to 12 o'clock, 12 o'clock to 15 o'clock, 15 o'clock to 18 o'clock, 18 o'clock to 21 o'clock, and 21 o'clock to 24 o'clock. For example, the comparing unit 43 acquires, from the operation information 30, the digi-tacho data 6 of the vehicle 3 of the company A that has been informed of the accident-prone area information 32 in the before period. Subsequently, the comparing unit 43 selects pieces of the digi-tacho data 6 having successive date and times, from the acquired pieces of the digi-tacho data 6. The comparing unit 43 then determines whether hard braking was used in the selected record. When hard braking was used, the comparing unit 43 increments the “number of hard braking events” by 1, associating with the time of the selected record. For example, when any of the deceleration ranges per second in the selected records is equal to or more than 10 (km/h), and when the date and time corresponding to the selected record is “Oct. 15, 2012 19:01:23 to 27”, the following processing is performed. That is, the comparing unit 43 increments the “number of hard braking events” by 1, associating with the time frame of 18 o'clock to 21 o'clock. That is, the comparing unit 43 counts the number of hard braking events for each time frame. On the other hand, when hard braking was not used, the comparing unit 43 does not increment the “number of hard braking events”. The comparing unit 43 repeats the processing of selecting the digi-tacho data 6 having successive date and times from the acquired pieces of the digi-tacho data 6 until no piece of the digi-tacho data 6 that has not been selected remains, and thereby counts the number of hard braking events in the before period for each time frame.

Moreover, the comparing unit 43 counts the number of hard braking event in the after period for each time frame. For example, the comparing unit 43 acquires, from the operation information 30, the digi-tacho data 6 of the vehicle 3 of the company A that has been informed of the accident-prone area information 32 in the after period. Subsequently, the comparing unit 43 selects pieces of the digi-tacho data 6 having successive date and times, from the acquired pieces of the digi-tacho data 6. The comparing unit 43 then determines whether hard braking was used in the selected record. When hard braking was used, the comparing unit 43 increments the “number of hard braking events” by 1, associating with the time of the selected record. For example, when any of the deceleration ranges per second in the selected records is equal to or more than 10 (km/h), and when the date and time corresponding to the selected record is “Dec. 15, 2012 10:01:23 to 27”, the following processing is performed. That is, the comparing unit 43 increments the “number of hard braking events” by 1, associating with the time frame of 9 o'clock to 12 o'clock. That is, the comparing unit 43 counts the number of hard braking events for each time frame. On the other hand, when hard braking was not used, the comparing unit 43 does not increment the “number of hard braking events”. The comparing unit 43 repeats the processing of selecting the digi-tacho data 6 having successive date and times from the acquired pieces of the digi-tacho data 6 until no piece of the digi-tacho data 6 that has not been selected remains, and thereby counts the number of hard braking events in the after period for each time frame.

Subsequently, the comparing unit 43 counts the number of points at which hard braking occurs for each speed band as illustrated in FIG. 17. In FIG. 17, the horizontal direction corresponds to time frames of each three hours, and the vertical direction corresponds to the number of hard braking events. In the example illustrated in FIG. 17, the comparing unit 43 counts hard braking that occurred in the time frame of 0 o'clock to 3 o'clock in the before period, and acquires “6” times. Furthermore, the comparing unit 43 counts the number of hard braking that occurred in each of the time frames of 3 o'clock to 6 o'clock, 6 o'clock to 9 o'clock, 9 o'clock to 12 o'clock, 12 o'clock to 15 o'clock, 15 o'clock to 18 o'clock, 18 o'clock to 21 o'clock, and 21 o'clock to 24 o'clock in the before period. Moreover, the comparing unit 43 counts hard braking that occurred in the time frame of 0 o'clock to 3 o'clock in the after period, and acquires “0” times. Furthermore, the comparing unit 43 counts the number of hard braking that occurred in each of the time frames of 3 o'clock to 6 o'clock, 6 o'clock to 9 o'clock, 9 o'clock to 12 o'clock, 12 o'clock to 15 o'clock, 15 o'clock to 18 o'clock, 18 o'clock to 21 o'clock, and 21 o'clock to 24 o'clock in the after period.

As described, the comparing unit 43 performs comparison between the number of hard braking events in the before period and the number of hard braking events in the after period for each time frame by generating a comparison result as illustrated in FIG. 17. That is, according to the comparison result illustrated in FIG. 17, it is understood that the number of hard braking events has decreased by the introduction of the alerting service especially in the time frames of 0 o'clock to 3 o'clock and 18 o'clock to 21 o'clock. According to this, the comparing unit 43 can verify the effectiveness of introducing the alerting service according to time frames.

As described, the comparing unit 43 compares the number of hard braking events when alarm is issued and the number of hard braking events when alarm is not issued. Thus, the comparing unit 43 outputs a comparison result to the output control unit 44.

A case in which the comparison processing based on the number of hard braking events, the comparison processing based on the number of vehicles that have used hard braking, the comparison processing based on the number of areas in which hard braking has occurred, the comparison processing based on the vehicle speed at hard braking events, the comparison processing based on the number of hard braking events of each time frame are respectively performed has been explained herein. However, the disclosed techniques are not limited to thereto. For example, only an arbitrary comparison processing can be performed out of the comparison processing explained herein.

The output control unit 44 outputs a comparison result. For example, the output control unit 44 transmits a comparison result that is obtained as a result of comparison performed by the comparing unit 43 to the administrator terminal 4 through the communication unit 21. As an example, the output control unit 44 transmits the comparison results illustrated in FIG. 11 to FIG. 17 to the administrator terminal 4 through the communication unit 21. The destination to which the output control unit 44 transmits the comparison results is not necessarily the administrator terminal 4. For example, the output control unit 44 may transmit the comparison results to each of the digi-tachos that are mounted on the vehicles 3. Alternatively, the output control unit 44 may store the comparison results in a predetermined recording medium.

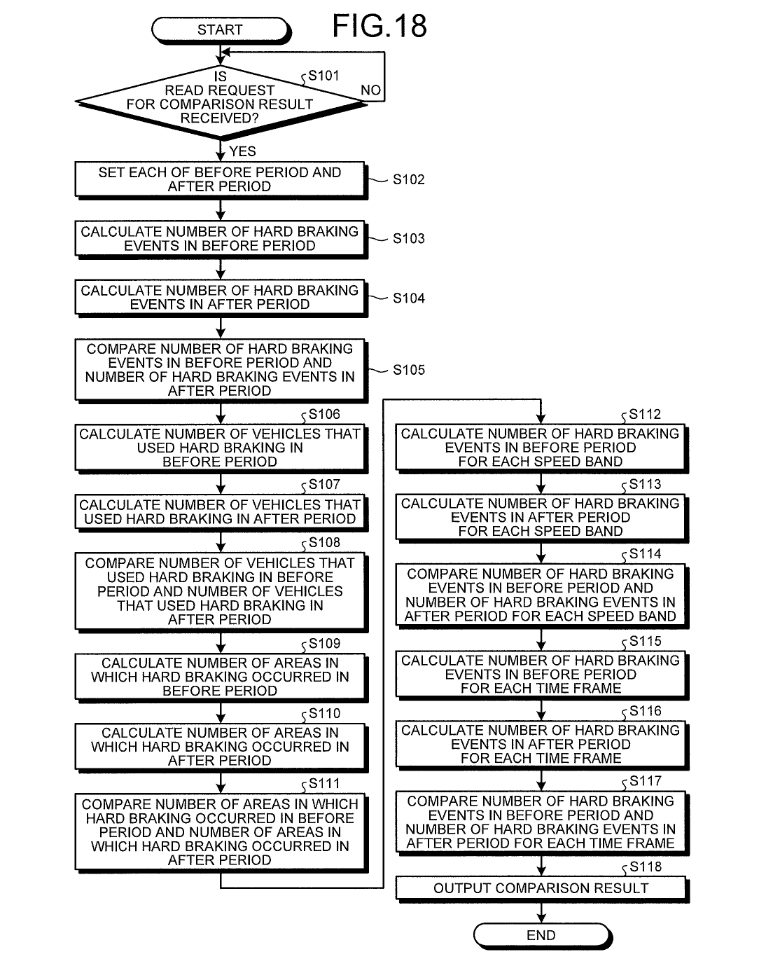

Next, a processing procedure of the information providing apparatus according to a second embodiment is explained. FIG. 18 is a flowchart of a processing procedure of the information providing apparatus according to the second embodiment.

As illustrated in FIG. 18, when a read request for a comparison result is received (S101: YES), the comparing unit 43 sets each of the before period and the after period (S102). For example, the comparing unit 43 refers to the alerting history 33, and sets each of the “before period” that is a predetermined period to be a comparison object among periods in which no alarm was issued, and the “after period” that is a predetermined period to be a comparison object among periods in which alarm was issued. Until a read request for a comparison result is received (S101: NO), the comparing unit 43 is in standby state.

Subsequently, the comparing unit 43 calculates the number of hard braking events in the before period (S103). The comparing unit 43 then calculates the number of hard braking events in the after period (S104). The comparing unit 43 compares the number of hard braking events in the before period and the number of hard braking events in the after period (S105). For example, the comparing unit 43 compares the number of hard braking events in the before period and the number of hard braking events in the after period by generating a comparison result as illustrated in FIG. 11.

Subsequently, the comparing unit 43 calculates the number of vehicles that used hard braking in the before period (S106). The comparing unit 43 then calculates the number of vehicles that used hard braking in the after period (S107). The comparing unit 43 compares the number of vehicles that used hard braking in the before period and the number of vehicles that used hard braking in the after period (S108). For example, the comparing unit 43 compares the number of vehicles that used hard braking in the before period and the number of vehicles that used hard braking in the after period by generating a comparison result as illustrated in FIG. 12 and FIG. 13.

Subsequently, the comparing unit 43 calculates the number of areas in which hard braking occurred in the before period (S109). The comparing unit 43 then calculates the number of areas in which hard braking occurred in the after period (S110). The comparing unit 43 compares the number of areas in which hard braking occurred in the before period and the number of areas in which hard braking occurred in the after period (S111). For example, the comparing unit 43 compares the number of areas in which hard braking occurred in the before period and the number of areas in which hard braking occurred in the after period by generating a comparison result as illustrated in FIG. 14 and FIG. 15.

Subsequently, the comparing unit 43 calculates the number of hard braking events in the before period for each time frame (S115). The comparing unit 43 then calculates the number of hard braking events in the after period for each time frame (S116). The comparing unit 43 compares the number of hard braking events in the before period and the number of hard braking events in the after period, for each time frame (S117). For example, the comparing unit 43 compares the number of hard braking events in the before period and the number of hard braking events in the after period, for each time frame by generating a comparison result as illustrated in FIG. 17.

The output control unit 44 outputs the comparison results obtained by comparison performed by the comparing unit 43 to the administrator terminal 4 through the communication unit 21 (S118), and ends the processing.

The processing procedure described above is one example, and not all of the processing described above is necessarily performed. For example, the processing from S103 to S105 to compare the numbers of hard braking events is not necessarily performed. Furthermore, for example, the processing from S106 to S108 to compare the numbers of vehicles that used hard braking is not necessarily performed. Moreover, for example, the processing from S109 to S111 to compare the numbers of areas in which hard braking occurred is not necessarily performed. Furthermore, for example, the processing from S112 to S114 to compare the vehicle speeds at hard braking events is not necessarily be performed. Moreover, for example, the processing from S115 to S117 to compare the number of hard braking events of each time frame is not necessarily performed.

As described above, the information providing apparatus 20 performs comparison between the first driving data when alarm is issued for a driver driving at a certain point on a road and the second driving data when the alarm is not issued for the driver driving thereon, and outputs a comparison result. Thus, the information providing apparatus 20 can ascertain the effectiveness of introducing the alerting service.

### [c] Third Embodiment

Although a case in which the information providing apparatus 20 performs comparison using the number of hard braking events has been explained in the second embodiment, the disclosed techniques are not limited thereto. For example, the information providing apparatus 20 may perform comparison using variations in speed of the vehicle 3 in an alerting area in which an alarm is issued by the alerting service. Accordingly, in a third embodiment, a case in which the information providing apparatus 20 performs comparison using variations in speed of the vehicle 3 in an alerting area is explained.

Although a configuration of the information providing apparatus 20 according to the third embodiment is basically similar to the configuration of the information providing apparatus 20 explained in the second embodiment using FIG. 2, a part of the processing by the comparing unit 43 is different. Therefore, in the third embodiment, different points from the information providing apparatus 20 explained in the second embodiment are explained, and explanation for the similar points is omitted.

The comparing unit 43 has the functions explained in the first embodiment. The comparing unit 43 further compares variations in speed of the vehicle 3 when an alarm is issued and variations in speed of the vehicle 3 when an alarm is not issued in an alerting area.

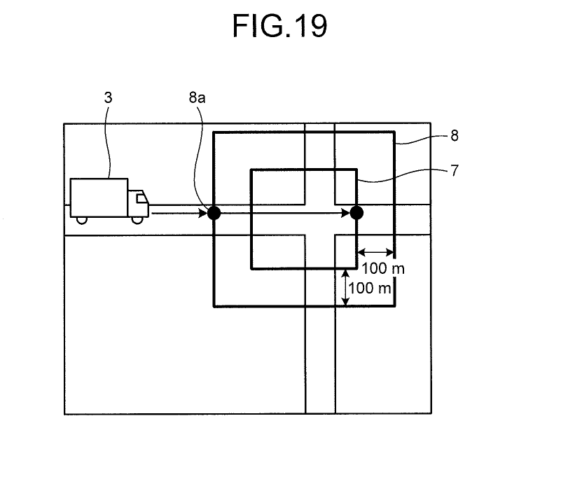

The alerting area is explained herein. FIG. 19 is an explanatory diagram of the alerting area. As illustrated in FIG. 19, an alerting area 8 is set at a predetermined distance, for example, 100 meters (m) outside an area 7 that corresponds to a frequent hard-braking area. In this case, the digi-tacho mounted on the vehicle 3 issues an alarm when the vehicle 3 passes a point 8a. In the following, explanation is given providing examples of a comparison result that is generate by the comparing unit 43.

### Comparison Result Example 6

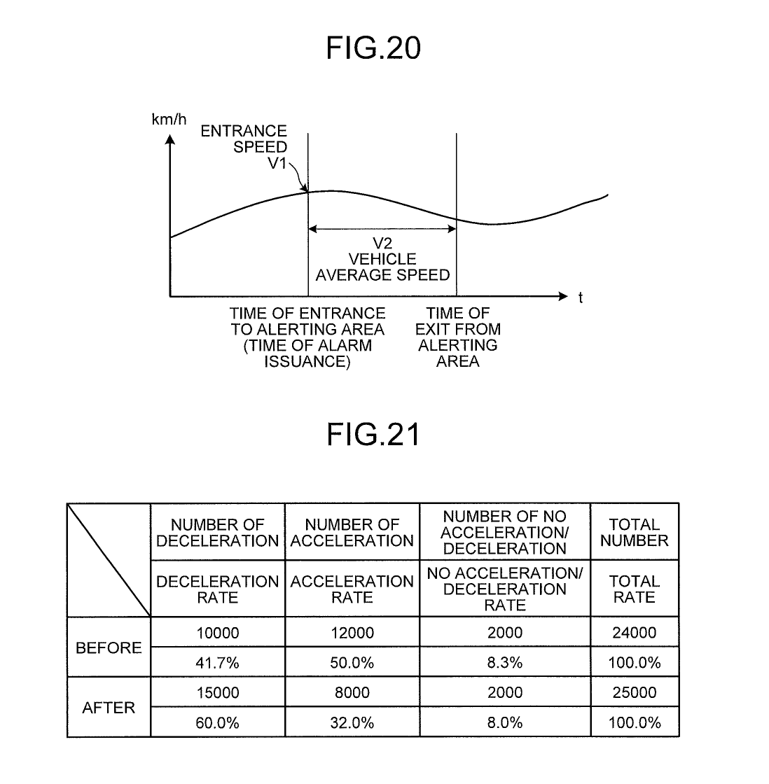

A case in which the comparing unit 43 performs comparison based on variations in speed in the alerting area 8 is explained using FIG. 20 and FIG. 21. This is because it is assumed that when an alarm is issued, deceleration is performed for a certain amount of time after entrance to the frequent hard-braking area, and such state continues.

FIG. 20 is a diagram for explaining comparison based on variations in speed in the alerting area. FIG. 20 is an example of a graph in which the speed of the vehicle 3 that is traveling in the frequent hard-braking area is plotted with time. In FIG. 20, the horizontal direction corresponds to time and the vertical direction corresponds to the speed of the vehicle 3. As illustrated in FIG. 20, the vehicle 3 that drives in the frequent hard-braking area is assumed to decelerate upon entrance to the alerting area 8, that is, upon issuance of an alarm, until exit from the alerting area 8. That is, when the speed at the time of entrance to the alerting area 8 is an entrance speed V1 and the average speed from the entrance to the alerting area 8 to the exit from the alerting area 8 is a vehicle average speed V2, it is assumed that the rate of being “V1−V2>0” is high. Therefore, the comparing unit 43 defines a case of “V1−V2>0” as “deceleration”, “V1−V2<0” as “acceleration”, and “V1−V2=0” as “no acceleration/deceleration”, and counts the number of each case.

First, a case in which the comparing unit 43 counts the number in the before period is explained. For example, the comparing unit 43 acquires, from the operation information 30, the digi-tacho data 6 that was traveling in the frequent hard-braking area in the before period. The comparing unit 43 then selects pieces of the digi-tacho data 6 having successive date and times, from the acquired pieces of the digi-tacho data 6. The comparing unit 43 determines the speed corresponding to the date and time of the oldest record among the selected records as the entrance speed V1. The comparing unit 43 calculates the average of the speed of all records included in the selected records, and determines the value obtained by calculation as the vehicle average speed V2. The comparing unit 43 then calculates “V1−V2”, and increments the “number of deceleration” by 1 if the value obtained by calculation is a positive value. Thus, the comparing unit 43 acquires “10000” times by counting the number of deceleration in the before period as illustrated in FIG. 21. Furthermore, the comparing unit 43 calculates “V1−V2”, and increments the “number of acceleration” by 1 if the value obtained by calculation is a negative value. Thus, the comparing unit 43 acquires “12000” times by counting the number of acceleration in the before period as illustrated in FIG. 21. Moreover, the comparing unit 43 calculates “V1−V2”, and increments the “number of no acceleration/deceleration” by 1 if the value obtained by calculation is 0. Thus, the comparing unit 43 acquires “2000” times by counting the number of no acceleration/deceleration in the before period as illustrated in FIG. 21. The comparing unit 43 repeats the processing of selecting the digi-tacho data 6 having successive date and times from the acquired pieces of the digi-tacho data 6 until no piece of the digi-tacho data 6 that has not been selected remains. Thus, the comparing unit 43 counts each of the “number of deceleration”, the “number of acceleration”, and the “number of no acceleration/deceleration”.

Subsequently, the comparing unit 43 calculates respective rates of the “number of deceleration”, the “number of acceleration”, and the “number of no acceleration/deceleration” in the before period. For example, the comparing unit 43 calculates a “total number” by totalizing the “number of deceleration”, the “number of acceleration”, and the “number of no acceleration/deceleration”. Thus, the comparing unit 43 acquires “24000” times as the total number in the before period as illustrated in FIG. 21. The comparing unit 43 then calculates the rate of the “number of deceleration” to the “total number”, and thereby calculates a “deceleration rate”. Thus, the comparing unit 43 acquires the deceleration rate in the before period “41.7%” as illustrated in FIG. 21. Furthermore, the comparing unit 43 calculates the rate of the “number of acceleration” to the “total number”, and thereby calculates an “acceleration rate”. Thus, the comparing unit 43 acquires the acceleration rate in the before period “50%” as illustrated in FIG. 21. Moreover, the comparing unit 43 calculates the rate of the “number of no acceleration/deceleration” to the “total number”, and thereby calculates a “no acceleration/deceleration rate”. Thus, the comparing unit 43 acquires the no acceleration/deceleration rate in the before period “8.3%” as illustrated in FIG. 21. As described, the comparing unit 43 calculates each of the “deceleration rate”, the “acceleration rate”, and the “no acceleration/deceleration rate”.

Next, the comparing unit 43 counts each of the “number of deceleration”, the “number of acceleration”, and the “number of no acceleration/deceleration” in the after period. This processing is similar to the processing of counting each of the “number of deceleration”, the “number of acceleration”, and the “number of no acceleration/deceleration” in the before period, except that the digi-tacho data 6 of the after period is used, and therefore, explanation thereof is omitted.

Subsequently, the comparing unit 43 calculates respective rates of the “number of deceleration”, the “number of acceleration”, and the “number of no acceleration/deceleration” in the after period. This processing is also similar to the processing of calculating each of the “deceleration rate”, the “acceleration rate”, and the “no acceleration/deceleration rate” in the before period, and therefore the explanation thereof is omitted.

As described, the comparing unit 43 performs comparison based on variations in speed in the alerting area 8 by generating a comparison result as illustrated in FIG. 21. That is, according to the comparison result illustrated in FIG. 21, it is understood that the number of deceleration and the deceleration rate are increased by the introduction of the alerting service. Furthermore, according to the comparison result illustrated in FIG. 21, it is understood that the number of the acceleration and the acceleration rate are decreased by the introduction of the alerting service. With this, the comparing unit 43 can verify the effectiveness of introducing the alerting service using precise variations in speed of the vehicle 3 in the alerting area 8. Furthermore, the comparing unit 43 can verify the effectiveness of introducing the alerting service based on more number of entrances compared to when comparison is performed based on the number of hard braking events.

### Comparison Result Example 7

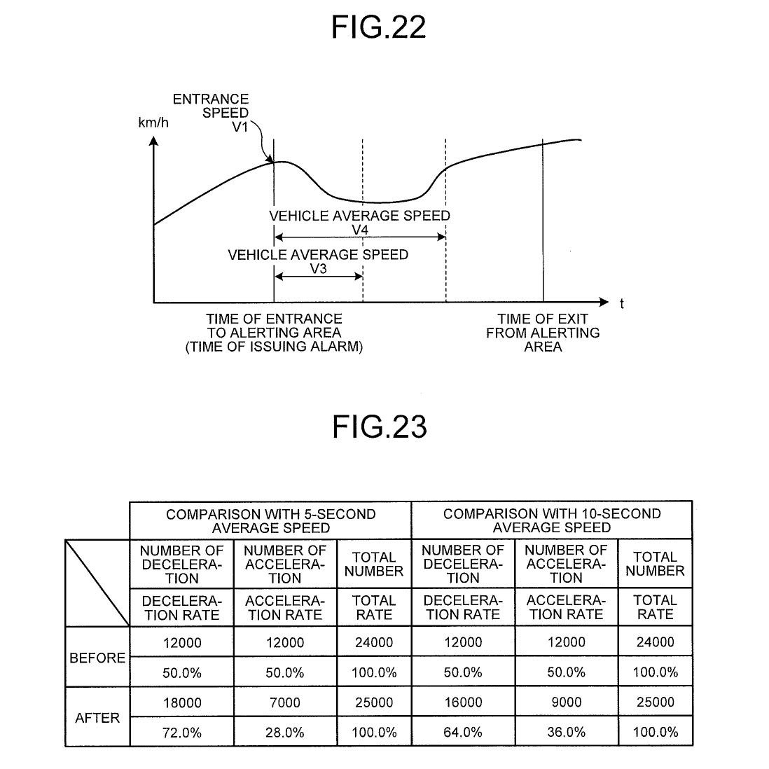

A case in which the comparing unit 43 performs comparison based on variations in speed in a predetermined range is explained using FIG. 22 and FIG. 23. The comparing unit 43 performs comparison using variations in speed in “5 seconds” or “10 seconds” from the time of entrance to the alerting area 8. This is because the time from the entrance to the alerting area 8 to the exit from the alerting area 8 can be long depending on frequent hard-braking areas for the comparison result illustrated in FIG. 21. In this case, even if deceleration occurs soon after an alarm is issued, the speed when accelerated thereafter can also be included in a comparison object. In other words, this is because it is considered that this enables comparison of variations in speed based on a uniform criterion that does not vary depending on the size of frequent hard-braking areas.

FIG. 22 is a diagram for explaining comparison based on variations in speed in a predetermined range. FIG. 22 is an example of a graph in which the speed of the vehicle 3 that is traveling in a frequent hard-braking area is plotted with time. In FIG. 22, the horizontal direction corresponds to time and the vertical direction corresponds to the speed of the vehicle 3. As illustrated in FIG. 22, the speed at the time of entrance to the alerting area 8 is referred to as the entrance speed V1, the average speed in a period of 5 seconds from the time of entrance to the alerting area 8 is referred to as a vehicle average speed V3, and the average speed in a period of 10 seconds from the time of entrance to the alerting area 8 is referred to as a vehicle average speed V4. In this case, the comparing unit 43 defines cases that apply to “V1−V3≧0” or “V1−V4≧0” as “deceleration”, and cases that apply to “V1−V3<0” or “V1−V4<0” as “acceleration”, and counts the frequency of each case.

First, a case in which the comparing unit 43 counts the frequency in the before period is explained. For example, the comparing unit 43 acquires, from the operation information 30, the digi-tacho data 6 that was driving in a frequent hard-braking area. The comparing unit 43 then selects pieces of the digi-tacho data 6 having successive date and times, from the acquired pieces of the digi-tacho data 6. The comparing unit 43 determines the speed corresponding to the date and time of the oldest record among the selected records as the entrance speed V1. The comparing unit 43 calculates the average of the speed of records included in 5 seconds from the oldest record among the selected records, and determines the calculated value as the vehicle average speed V3. Moreover, the comparing unit 43 calculates the average of the speed of records included in 10 seconds from the oldest record among the selected records, and determines the calculated value as the vehicle average speed V4. The comparing unit 43 calculates “V1−V3”, and if the calculated value is 0 or larger, increments the “number of deceleration” in comparison with the 5-second average speed by 1. Thus, the comparing unit 43 acquires “12000” times by counting the number of deceleration in comparison with the 5-second average speed in the before period as illustrated in FIG. 23. Moreover, the comparing unit 43 calculates “V1−V3”, and if the calculated value is a negative value, increments the “number of acceleration” in comparison with the 5-second average speed by 1. Thus, the comparing unit 43 acquires “12000” times by counting the number of acceleration in comparison with the 5-second average speed in the before period as illustrated in FIG. 23. Furthermore, The comparing unit 43 calculates “V1−V4”, and if the calculated value is 0 or larger, increments the “number of deceleration” in comparison with the 10-second average speed by 1. Thus, the comparing unit 43 acquires “12000” times by counting the number of deceleration in comparison with the 10-second average speed in the before period as illustrated in FIG. 23. Moreover, the comparing unit 43 calculates “V1−V4”, and if the calculated value is a negative value, increments the “number of acceleration” in comparison with the 10-second average speed by 1. Thus, the comparing unit 43 acquires “12000” times by counting the number of acceleration in comparison with the 10-second average speed in the before period as illustrated in FIG. 23.

Subsequently, the comparing unit 43 calculates the respective rates of the “number of deceleration” in comparison with the 5-second average speed, and the “number of acceleration” in comparison with the 5-second average speed in the before period. For example, the comparing unit 43 totalizes the “number of deceleration” in comparison with the 5-second average speed, and the “number of acceleration” in comparison with the 5-second average speed, and thereby calculates the “total number” in comparison with the 5-second average speed. Thus, the comparing unit 43 acquires the total number “24000” times in comparison with the 5-second average speed in the before period as illustrated in FIG. 23. The comparing unit 43 then calculates the rate of the “number of deceleration” in comparison with the 5-second average speed to the “total number” in comparison with the 5-second average speed, to acquire the “deceleration rate” in comparison with the 5-second average speed. Thus, the comparing unit 43 calculates “50%” for the deceleration rate in comparison with the 5-second average speed in the before period as illustrated in FIG. 23. Furthermore, the comparing unit 43 calculates the rate of the “number of acceleration” in comparison with the 5-second average speed to the “total number” in comparison with the 5-second average speed, to acquire the “acceleration rate” in comparison with the 5-second average speed. Thus, the comparing unit 43 calculates “50%” for the acceleration rate in comparison with the 5-second average speed in the before period as illustrated in FIG. 23. As described, the comparing unit 43 calculates each of the “deceleration rate” in comparison with the 5-second average speed and the “acceleration rate” in comparison with the 5-second average speed in the before period.

Next, the comparing unit 43 calculates the respective rates of the “number of deceleration” in comparison with the 10-second average speed and the “number of acceleration” in comparison with the 10-second average speed in the before period. This processing is similar to the processing of calculating the respective rates of the “number of deceleration” in comparison with the 5-second average speed and the “number of acceleration” in comparison with the 5-second average speed in the before period, and therefore, the explanation thereof is omitted.

Next, the comparing unit 43 counts each of the “number of deceleration” and the “number of acceleration” in the after period. This processing is similar to the processing of counting each of the “number of deceleration” and the “number of acceleration” in the before period described above except that the digi-tacho data 6 of the after period is used, and therefore, the explanation thereof is omitted.

Subsequently, the comparing unit 43 calculates the respective rates of the “number of deceleration” and the “number of acceleration” in the after period. This processing is also similar to the processing of calculating each of the “deceleration rate” and the “acceleration rate” in the before period described above, and therefore, the explanation thereof is omitted.

As described, the comparing unit 43 performs comparison based on variations in speed in “5 seconds” or “10 seconds” from the time of entrance to the alerting area 8, by generating a comparison result as illustrated in FIG. 23. That is, according to the comparison result illustrated in FIG. 23, it is understood that the number of deceleration and the deceleration rate in comparison with the 5-second average speed are increased by the introduction of the alerting service. Moreover, according to the comparison result illustrated in FIG. 21, it is understood that the number of acceleration and the acceleration rate in comparison with the 5-second average speed are decreased by the introduction of the alerting service. Furthermore, according to the comparison result illustrated in FIG. 23, it is understood that the number of deceleration and the deceleration rate in comparison with the 10-second average speed are increased by the introduction of the alerting service. Moreover, according to the comparison result illustrated in FIG. 21, it is understood that the number of acceleration and the acceleration rate in comparison with the 10-second average speed are decreased by the introduction of the alerting service. With this, the comparing unit 43 can verify the effectiveness of introducing the alerting service based on the uniform criterion that does not vary depending on the size of frequent hard-braking areas.

### Comparison Result Example 8

A case in which the comparing unit 43 performs comparison based on variation in speed in a predetermined speed band is explained. For example, the comparing unit 43 performs comparison using the vehicle average speed V3 or the vehicle averages speed V4 when the entrance speed V1 is in a predetermined speed band, for example, 50 km/h or higher. This is because there is possibility that issuance of an alarm does not necessarily lead to deceleration, due to traffic congestion or stop at a traffic light. In other words, by removing the influence of the traffic congestion or stop at a traffic light, variations in speed can be verified using the digi-tacho data 6 of a speed closer to an actual driving speed.

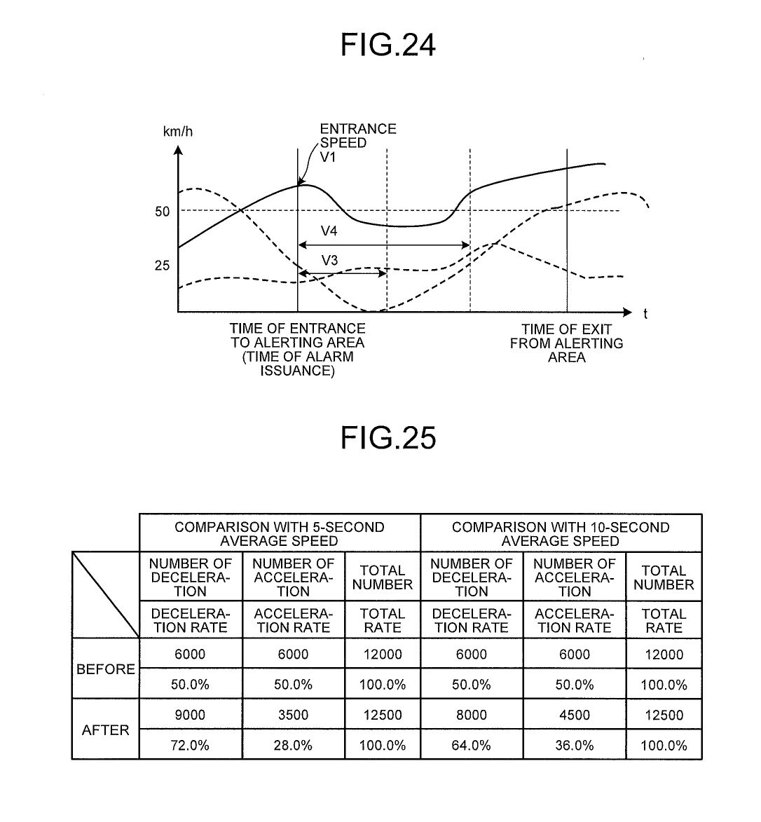

FIG. 24 is a diagram for explaining comparison based on variations in speed in a predetermined speed band. FIG. 24 is an example of a graph in which the speed of the vehicle 3 that is traveling in a frequent hard-driving area is plotted with time. In FIG. 24, the horizontal direction corresponds to time and the vertical direction corresponds to the speed of the vehicle 3. As illustrated in FIG. 24, the speed at the time of entrance to the alerting area 8 is referred to as the entrance speed V1, the average speed in seconds from the time of entrance to the alerting area 8 is referred to as the vehicle average speed V3, and the average speed in 10 seconds from the time of entrance to the alerting area 8 is referred to as the vehicle average speed V4. When “V1≧50 km/h”, the comparing unit 43 defines cases that apply “V1−V3≧0” or “V1−V4≧0” as “deceleration”, and cases that apply “V1−V3<0” or “V1−V4<0” as “acceleration”, and counts the frequency of each case. That is, in the example illustrated in FIG. 24, the comparing unit 43 performs the processing of counting on the digi-tacho data 6 indicated by a solid line, and does not perform the processing of counting on the digi-tacho data 6 that is indicated by a broken line.

First, a case in which the comparing unit 43 counts the frequency in the before period is explained. For example, the comparing unit 43 acquires, from the operation information 30, the digi-tacho data 6 that was traveling in a frequent hard-braking area in the before period. The comparing unit 43 then selects pieces of the digi-tacho data 6 having successive date and times, from the acquired pieces of the digi-tacho data 6. The comparing unit 43 determines the speed corresponding to the date and time of the oldest record among the selected records as the entrance speed V1. The comparing unit 43 determines whether V1 is equal to or higher than 50 km/h, and when V1 is equal to or higher than 50 km/h, the following processing is performed. That is, the comparing unit 43 calculates the average of the speed of records included in 5 seconds from the oldest record among the selected records, and determines the calculated value as the vehicle average speed V3. Moreover, the comparing unit 43 calculates the average of the speed of records included in 10 seconds from the oldest record among the selected records, and determines the calculated value as the vehicle average speed V4. The comparing unit 43 calculates “V1−V3”, and if the calculated value is 0 or larger, increments the “number of deceleration” in comparison with the 5-second average speed by 1. Thus, the comparing unit 43 counts “6000” times for the number of deceleration in comparison with the 5-second average speed in the before period as illustrated in FIG. 25. Moreover, the comparing unit 43 calculates “V1−V3”, and if the calculated value is a negative value, increments the “number of acceleration” in comparison with the 5-second average speed by 1. Thus, the comparing unit 43 counts “6000” times for the number of acceleration in comparison with the 5-second average speed in the before period as illustrated in FIG. 25. Furthermore, The comparing unit 43 calculates “V1−V4”, and if the calculated value is 0 or larger, increments the “number of deceleration” in comparison with the 10-second average speed by 1. Thus, the comparing unit 43 counts “6000” times for the number of deceleration in comparison with the 10-second average speed in the before period as illustrated in FIG. 25. Moreover, the comparing unit calculates “V1−V4”, and if the calculated value is a negative value, increments the “number of acceleration” in comparison with the 10-second average speed by 1. Thus, the comparing unit 43 counts “6000” times for the number of acceleration in comparison with the 10-second average speed in the before period as illustrated in FIG. 25. The comparing unit 43 does not count the selected records when V1 is lower than 50 km/h, and repeats the processing of selecting the digi-tacho data with successive date and times until no record that has not been selected remains.

Subsequently, the comparing unit 43 calculates the respective rates of the “number of deceleration” in comparison with the 5-second average speed, and the “number of acceleration” in comparison with the 5-second average speed in the before period. For example, the comparing unit 43 totalizes the “number of deceleration” in comparison with the 5-second average speed, the “number of acceleration” in comparison with the 5-second average speed, and thereby calculates the “total number” in comparison with the 5-second average speed. Thus, the comparing unit 43 acquires the total number “12000” times in comparison with the 5-second average speed in the before period as illustrated in FIG. 25. The comparing unit 43 then calculates the rate of the “number of deceleration” in comparison with the 5-second average speed to the “total number” in comparison with the 5-second average speed, to acquire the “deceleration rate” in comparison with the 5-second average speed. Thus, the comparing unit 43 calculates “50%” for the deceleration rate in comparison with the 5-second average speed in the before period as illustrated in FIG. 25. Furthermore, the comparing unit 43 calculates the rate of the “number of acceleration” in comparison with the 5-second average speed to the “total number” in comparison with the 5-second average speed, to acquire the “acceleration rate” in comparison with the 5-second average speed. Thus, the comparing unit 43 calculates “50%” for the acceleration rate in comparison with the 5-second average speed in the before period as illustrated in FIG. 25. As described, the comparing unit 43 calculates each of the “deceleration rate” in comparison with the 5-second average speed and the “acceleration rate” in comparison with the 5-second average speed in the before period.

Next, the comparing unit 43 calculates the respective rates of the “number of deceleration” in comparison with the 10-second average speed and the “number of acceleration” in comparison with the 10-second average speed in the before period. This processing is similar to the processing of calculating the respective rates of the “number of deceleration” in comparison with the 5-second average speed and the “number of acceleration” in comparison with the 5-second average speed in the before period, and therefore, the explanation thereof is omitted.

Next, the comparing unit 43 counts each of the “number of deceleration” and the “number of acceleration” in the after period. This processing is similar to the processing of counting each of the “number of deceleration” and the “number of acceleration” in the before period described above except that the digi-tacho data 6 of the after period is used, and therefore, the explanation thereof is omitted.

Subsequently, the comparing unit 43 calculates the respective rates of the “number of deceleration” and the “number of acceleration” in the after period. This processing is also similar to the processing of calculating each of the “deceleration rate” and the “acceleration rate” in the before period, and therefore, the explanation thereof is omitted.

As described, the comparing unit 43 performs comparison based on variations in speed in “5 seconds” or “10 seconds” from the time of entrance to the alerting area 8 for a predetermined speed band, by generating a comparison result as illustrated in FIG. 25. That is, according to the comparison result illustrated in FIG. 25, it is understood that the number of deceleration and the deceleration rate in comparison with the 5-second average speed are increased by the introduction of the alerting service. Moreover, according to the comparison result illustrated in FIG. 21, it is understood that the number of acceleration and the acceleration rate in comparison with the 5-second average speed are decreased by the introduction of the alerting service. Furthermore, according to the comparison result illustrated in FIG. 23, it is understood that the number of deceleration and the deceleration rate in comparison with the 10-second average speed are increased by the introduction of the alerting service. Moreover, according to the comparison result illustrated in FIG. 21, it is understood that the number of acceleration and the acceleration rate in comparison with the 10-second average speed are decreased by the introduction of the alerting service. With this, the comparing unit 43 can exclude the influence of traffic congestion or stop at a traffic light, and can verify variations in speed using the digi-tacho data 6 of a speed that is closer to an actual driving speed.

### Comparison Result Example 9

A case in which the comparing unit 43 performs comparison based on variations in speed before and after alerting is explained. For example, the comparing unit 43 performs comparison using an “acceleration range before entrance ΔV1” and an “acceleration range after entrance ΔV2”. This is because it is possible that even if a brake pedal is not pushed soon after an alarm is issued, such an action of easing the degree of acceleration, for example, easing an accelerator pedal, or releasing the pedal, is performed. That is, it is assumed that the rate of being “ΔV1>ΔV2” becomes high.

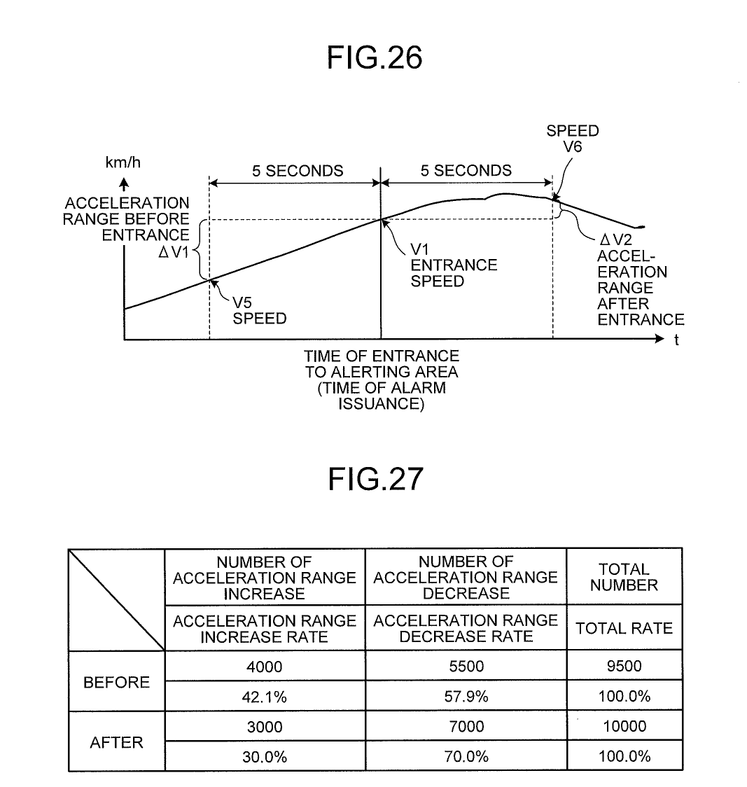

FIG. 26 is a diagram for explaining comparison based on variations in speed before and after alerting. FIG. 26 is an example of a graph in which the speed of the vehicle 3 that is traveling in a frequent hard-braking area is plotted with time. In FIG. 26, the horizontal direction corresponds to time and the vertical direction corresponds to the speed of the vehicle 3. As illustrated in FIG. 26, the speed at the time of entrance to the alerting area 8 is referred to as the entrance speed V1, the speed 5 seconds before the entrance to the alerting area 8 from the time of entrance to the alerting area 8 is referred to as a speed V5, and the speed 5 seconds after the entrance to the alerting area 8 is referred to as a speed V6. Moreover a value of “V1−V5” is referred to as an acceleration range before the entrance “ΔV1”, and a value of “V6−V1” is referred to as an acceleration range after the entrance “ΔV2”. In this case, the comparing unit 43 defines cases that apply to “ΔV1≧ΔV2” as “acceleration range decrease”, and cases that apply to “ΔV1<ΔV2” as “acceleration range increase”, and counts the frequency of each case. Note that only the digi-tacho data 6 that applies to “ΔV1>0” is counted.

First, a case in which the comparing unit 43 counts the frequency in the before period is explained. For example, the comparing unit 43 acquires, from the operation information 30, the digi-tacho data 6 that was traveling in a frequent hard-braking area in the before period. The comparing unit 43 then selects pieces of the digi-tacho data 6 having successive date and times, from the acquired pieces of the digi-tacho data 6. The comparing unit 43 determines the speed corresponding to the date and time of the oldest record among the selected records as the entrance speed V1. Moreover, the comparing unit 43 refers to the operation information 30, and determines the speed 5 seconds before the date and time of the oldest record among the selected records as the speed V5. Furthermore, the comparing unit 43 refers to the operation information 30, and determines the speed 5 seconds after the date and time of the oldest record among the selected records as the speed V6. The comparing unit 43 then calculates a value of “V1−V5”, and if the value is 0 or larger, the value is referred to as “ΔV1”. Moreover, the comparing unit 43 calculates a value of “V6−V1”, and the calculated value is referred to as “ΔV2”. Subsequently, the comparing unit 43 calculates “ΔV1−ΔV2”, and if the calculated value is a negative value, increments a “number of acceleration range increase” by 1. Thus, the comparing unit 43 counts “4000” times as the number of acceleration range increase in the before period as illustrated in FIG. 27. The comparing unit 43 calculates “ΔV1−ΔV2”, and if the calculated value is 0 or larger, increments the “number of acceleration range decrease” by 1. Thus, the comparing unit 43 counts “5500” times for the number of acceleration range decrease in the before period as illustrated in FIG. 27.

Subsequently, the comparing unit 43 calculates the respective rates of the “number of acceleration range increase” and the “number of acceleration range decrease” in the before period. For example, the comparing unit 43 totalizes the “number of acceleration range increase” and the “number of acceleration range decrease”, to calculate the “total number”. Thus, the comparing unit 43 counts the total number “9500” times in the before period as illustrated in FIG. 27. The comparing unit 43 then calculates the rate of the “number of acceleration range increase” to the “total number”, to calculate an “acceleration-range increase rate”. Thus, the comparing unit 43 acquires “42.1%” for the acceleration-rage increase rate in the before period as illustrated in FIG. 27. The comparing unit 43 then calculates the rate of the “number of acceleration range decrease” to the “total number”, and thereby calculates an “acceleration-range decrease rate”. Thus, the comparing unit 43 acquires “57.9%” for the acceleration-range decrease rate in the before period as illustrated in FIG. 27. As described, the comparing unit 43 calculates each of the “acceleration-range increase rate” and the “acceleration-range decrease rate” in the before period.

Next, the comparing unit 43 counts each of the “number acceleration range increase” and the “number of acceleration range decrease” in the after period. This processing is similar to the processing of counting each of the “number of acceleration range increase” and the “number of acceleration range decrease” in the before period described above except that the digi-tacho data 6 of the after period is used, and therefore, the explanation thereof is omitted.

Subsequently, the comparing unit 43 calculates the respective rates of the “number acceleration range increase” and the “number of acceleration range decrease” in the after period. This processing is also similar to the processing of calculating the “acceleration-range increase rate” and the “acceleration-range decrease rate” in the before period described above, and therefore, the explanation thereof is omitted.

As described, the comparing unit 43 performs comparison based on variations in speed before and after alerting by generating a comparison result as illustrated in FIG. 27. That is, according to the comparison result illustrated in FIG. 27, it is understood that the “acceleration-range increase rate” is decreased by the introduction of the alerting service. Moreover, according to the comparison result illustrated in FIG. 21, it is understood that the “acceleration-range decrease rate” is increased by the introduction of the alerting service. With this, the comparing unit 43 can verify the effectiveness of introducing the alerting service by an action of easing the acceleration degree.

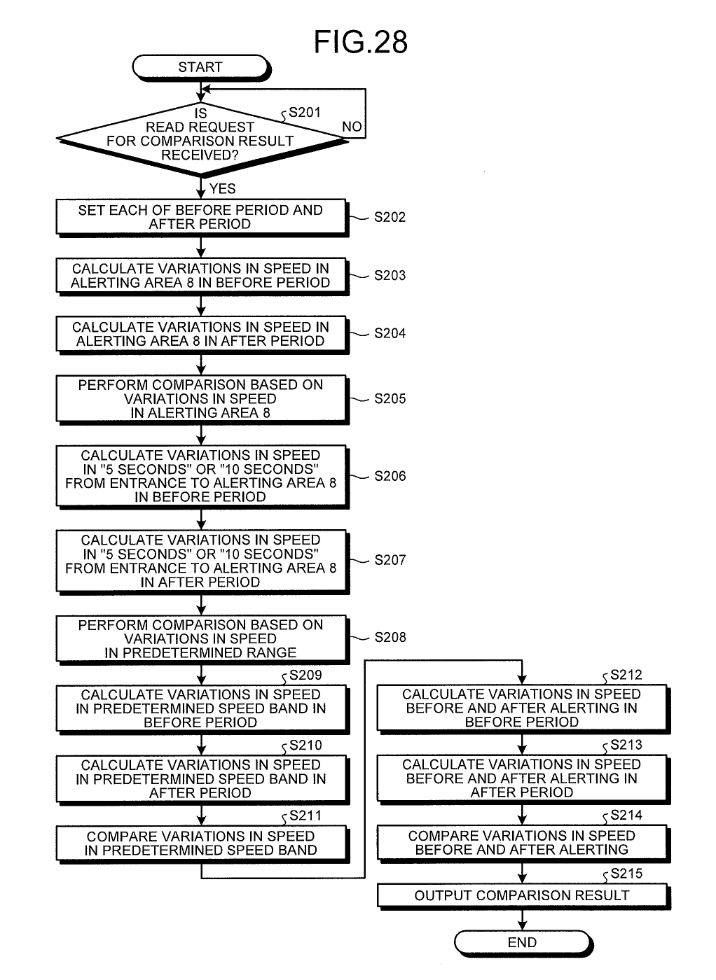

Next, a processing procedure of an information providing apparatus according to a third embodiment is explained. FIG. 28 is a flowchart of the processing procedure of the information providing apparatus according to the third embodiment.

As illustrated in FIG. 28, when a read request for a comparison result is received (S201: YES), the comparing unit 43 sets each of the before period and the after period (S202). For example, the comparing unit 43 refers to the alerting history 33, and sets each of the “before period” that is a predetermined period to be a comparison object out of periods in which no alarm was issued, and the “after period” that is a predetermined period to be a comparison object out of periods in which alarm was issued. Until a read request for a comparison result is received (S201: NO), the comparing unit 43 is in standby state.

Subsequently, the comparing unit 43 calculates the variations in speed in the alerting area 8 in the before period (S203). The comparing unit 43 then calculates the variations in speed in the alerting area 8 in the after period (S204). The comparing unit 43 performs comparison based on variations in speed in the alerting area 8 (S205). For example, the comparing unit 43 compares the “number of deceleration”, the “number of acceleration”, and the “number of no acceleration/deceleration” in the before period, and the “number of deceleration”, the “number of acceleration”, and the “number of no acceleration/deceleration” in the after period, by generating a comparison result as illustrated in FIG. 21, respectively. Moreover, for example, the comparing unit 43 compares the “deceleration rate”, the “acceleration rate”, and the “no acceleration/deceleration rate” in the before period, and the “deceleration rate”, the “acceleration rate”, and the “no acceleration/deceleration rate” in the after period, respectively.

Subsequently, the comparing unit 43 calculates variations in speed in “5 seconds” or “10 seconds” from the time of entrance to the alerting area 8 in the before period (S206). The comparing unit 43 then calculates variations in speed in “5 seconds” or “10 seconds” from the time of entrance to the alerting area 8 in the after period (S207). The comparing unit 43 then performs comparison based on variations in speed in a predetermined range (S208). For example, the comparing unit 43 performs comparison based on variations in speed in “5 seconds” or “10 seconds” from the time of entrance to the alerting area 8 by generating a comparison result as illustrated in FIG. 23.

Subsequently, the comparing unit 43 calculates variations in speed in a predetermined speed band in the before period (S209). The comparing unit 43 then calculates variations in speed in a predetermined speed band in the after period (S210). The comparing unit 43 compares variations in speed in the predetermined speed band (S211). For example, the comparing unit 43 performs comparison based on variations in speed in “5 seconds” or “10 seconds” for the predetermined speed band, by generating a comparison result as illustrated in FIG. 25.

Subsequently, the comparing unit 43 calculates variations in speed before and after alerting in the before period (S212). The comparing unit 43 then calculates variations in speed before and after alerting in the after period (S213). The comparing unit 43 compares the variations in speed before and after alerting (S214). For example, the comparing unit 43 performs comparison based on variations in speed before and after alerting by generating a comparison result as illustrated in FIG. 27.

The output control unit 44 outputs a comparison result obtained by comparison performed by the comparing unit 43 to the administrator terminal 4 through the communication unit 21 (S215), and ends the processing.

The processing procedure described above is one example, and not all of the processing described above is necessarily required to be performed. For example, the processing from S203 to S205 to perform comparison based on variations in speed in the alerting area 8 is not necessarily required to be performed. Furthermore, for example, the processing from S206 to S208 to perform comparison based on variations in speed in a predetermined range is not necessarily required to be performed. Moreover, for example, the processing from S209 to S211 to compare variations in speed in a predetermined speed band is not necessarily required to be performed. Furthermore, the processing from S212 to S214 to compare variations in speed before and after alerting is not necessarily required to be performed.

As described, the information providing apparatus 20 performs comparison between the first driving data when an alarm is issued for a driver driving at a certain point on a road and the second driving data when an alarm is not issued for a driver driving thereon, and outputs a comparison result. Thus, the information providing apparatus 20 can ascertain the effectiveness of introducing the alerting service.

### [d] Fourth Embodiment

Although the embodiments of the disclosed apparatus have been explained, the disclose techniques can be executed in various different forms in addition to the embodiments described above. Therefore, other embodiments are explained below.

For example, a case in which comparison is performed using speed acquired from the digi-tacho data 6 has been explained in the embodiment described above, the disclosed techniques are not limited thereto. For example, the information providing apparatus 20 may perform comparison based on the number of revolutions of an engine when the number of revolutions of the engine is acquired from the digi-tacho data 6.

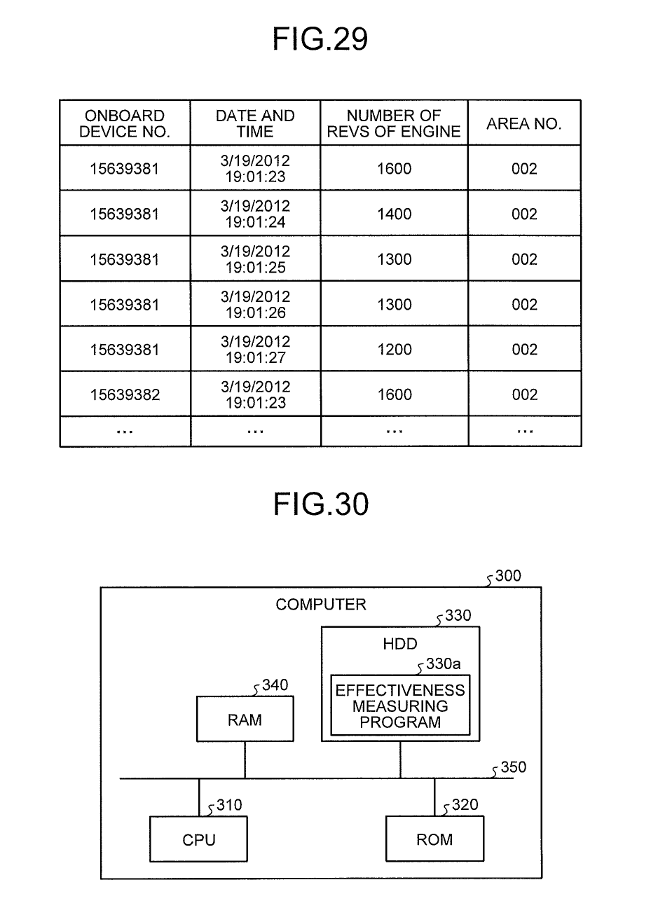

FIG. 29 is a diagram for explaining comparison based on driving data according to a fourth embodiment. As illustrated in FIG. 29, the information providing apparatus 20 acquires the number of revolutions per second when the vehicle 3 on which the digi-tacho of the onboard device No. “15639381” is mounted travels in the area of the area No. “002”. For example, the information providing apparatus 20 determines that hard braking has occurred when the acquired number of revolutions of the engine decreases by a predetermined number or more in one second. Thus, the information providing apparatus 20 can compare the number of hard braking events in the before period and the number of hard braking events in the after period also when the number of revolutions of an engine is acquired.

Furthermore, for example, although a case in which the effectiveness of introducing the alerting service is ascertained when the company A introduces the alerting service has been explained in the embodiment described above, the disclosed techniques are not limited thereto. For example, the disclosed techniques can be applied to when an individual uses the alerting service.

Moreover, although a case in which the digi-tacho data 6 of the before period and the digi-tacho data 6 of the after period are acquired from the operation information 30 that is recorded in past to be compared has been explained in the embodiment described above, it is not limited thereto. For example, the information providing apparatus 20 can acquire the digi-tacho data 6 that is generated in real time on the vehicle 3 currently running, as the digi-tacho data 6 of the after period to perform comparison. As an example, the information providing apparatus 20 calculates variations in speed in the alerting area 8 in the before period using the digi-tacho data 6 in the before period as described above. The information providing apparatus 20 then receives the digi-tacho data 6 that is transmitted in real time from a digi-tacho that is mounted on the vehicle 3 currently running, and calculates variations in speed in the alerting area 8 in the after period using the received digi-tacho data 6. The information providing apparatus 20 compares the variations in speed in the alerting area 8 in the before period and the variations in speed in the alerting area 8 in the after period.

Furthermore, for example, the disclosed technique can enable a setting to determine whether to provide a service of informing a driver currently driving about hard braking points. In this case, comparison between driving data when the service is provided and driving data when the service is not provided is performed to output a comparison result, and thereby the effectiveness of introducing the service is presented. For example, the information providing apparatus 20 includes a storage unit to set a time frame in which the alerting service described above is provided and a time frame in which the alerting service is not provided. Thus, the information providing apparatus 20 can switch on and off for the alerting service according to the set time frames. The information providing apparatus 20 is an example of a presenting apparatus.

Moreover, for example, the disclosed techniques can be a service providing method that is associated with a service that starts providing a service of informing about hard braking points to a driver currently driving according to a request for starting the service of informing about hard braking points to a driver currently driving. In this case, the information providing apparatus 20 identifies driving data that is collected before provision of the service is started by a request of starting the service, and compares the identified driving data that is collected before provision of the service and driving data that is collected after the request of starting the service, to output variations in driving conditions before and after start of provision of the service. The information providing apparatus 20 is an example of a service presenting apparatus.

Furthermore, for example, the disclosed technique can be a service providing method that is associated with a service that starts providing a service of informing about hard braking points to a driver currently driving according to a request for starting the service of informing about hard braking points to a driver currently driving. In this case, the information providing apparatus 20 updates hard braking points sequentially and informs about the hard braking points to a driver currently driving at positions that corresponds to the hard braking points that have been updated sequentially. The information providing apparatus 20 performs comparison between pieces of driving data that are collected at different points of time after a start of the service, and outputs variations in driving conditions under influence of the hard braking points that are changed by updates.

Moreover, the respective structural elements of each device illustrated in the drawings are of functional concepts, and it is not necessarily required to be configured physically as illustrated. That is, a specific state of decentralization and integration of the respective devices is not limited to the one illustrated, and it can be configured such that all or a part thereof is functionally or physically decentralized or integrated in an arbitrary unit according to various kinds of loads or use conditions. For example, the respective processing units of the extracting unit 41 and the analyzing unit 42 illustrated in FIG. 2 can be included in a separate apparatus from the information providing apparatus 20. Furthermore, all or arbitrary parts of the respective processing functions performed by the respective processing units can be implemented by a CPU and a program that is analyzed and executed by the CPU, or can be implemented as hardware by a wired logic.

### Effectiveness Measuring Program

Furthermore, the various kinds of processing of the information providing apparatuses 10 and 20 that are explained in the embodiments described above can be implemented by executing a program that is prepared in advance by a computer system such as a personal computer and a workstation. Accordingly, an example of a computer that executes an effectiveness measuring program having similar functions as those of the information providing apparatuses 10 and 20 explained in the embodiments described above is explained. FIG. 30 illustrates a computer that executes the effectiveness measuring program.

As illustrated in FIG. 30, a computer 300 includes a CPU 310, a read-only memory (ROM) 320, an HDD 330, and a RAM 340. The respective devices 310 to 340 are connected to each other through a bus 350.

In the ROM 320, a basic program such as an OS is stored. Moreover, in the HDD 330, an effectiveness measuring program 330a that fulfills similar functions as the respective functional units of the comparing unit 43 and the output control unit 44 described in the above embodiments is stored in advance. The effectiveness measuring program 330a can be distributed as appropriate. Furthermore, in the HDD 330, various kinds of data and various kinds of tables that are stored in the storage unit 22 are provided.

The CPU 310 reads and executes the effectiveness measuring program 330a from the HDD 330.

The CPU 310 reads the various kinds of data and various kinds of tables and stores in the RAM 340. Further, the CPU 310 executes the effectiveness measuring program 330a using the various kinds of data and various kinds of tables stored in the RAM 340. As for data stored in the RAM 340, not all of the data is always required to be stored in the RAM 340 as long as the data that is used in processing is stored in the RAM 340.

The effectiveness measuring program 330a is not necessarily required to be stored in the HDD 330 from the beginning.

For example, the effectiveness measuring program 330a is stored in a “portable physical medium” such as a flexible disk (FD), a compact-disc read-only memory (CD-ROM), a digital versatile disc (DVD), a magneto-optical disk, and an integrated circuit (IC) card that is inserted into a computer. It can be configured such that the computer reads and executes the effectiveness measuring program 330a from these media.

Furthermore, the effectiveness measuring program 330a can be stored in a “separate computer (or a server)” and the like that is connected to the computer 300 through a public circuit, the Internet, a local area network (LAN), a wide area network (WAN), and the like. It can be configured such that the computer reads and executes the effectiveness measuring program 330a from these.

The ascertainment of introducing an alerting service is enabled.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein an effectiveness measuring program that causes a computer to execute a process comprising:
performing comparison between first driving data and second driving data, the first driving data acquired when an alarm is issued for a driver driving at certain point on a road, and the second driving data acquired when the alarm is not issued for the driver driving thereon; and
outputting a comparison result.

2. The non-transitory computer-readable recording medium according to claim 1, wherein
the first driving data and the second driving data indicate a state of driving of entering the certain point in a predetermined similarity range.

3. The non-transitory computer-readable recording medium according to claim 1, wherein
the comparison result indicates whether the first driving data indicates an operation in a more decelerating direction compared to the second driving data.

4. The non-transitory computer-readable recording medium according to claim 1, wherein
the comparison is performed by comparing speed or number of revolutions of an engine indicated by each of the first driving data and the second driving data.

5. The non-transitory computer-readable recording medium according to claim 1, wherein
the comparison is performed by comparing driving data that corresponds to a position or an area in which the alarm has been issued, out of the first driving data.

6. A presentation method comprising:
presenting an effectiveness of introducing a service of informing a driver during driving of information related to a point where hard braking is apt to happen, by comparing driving data when the service is provided and driving data when the service is not provided, and outputting a comparison result.

7. A service providing method that is associated with a service of informing a driver currently driving of information related to a point where hard braking is apt to happen, according to a start request of the service, the method comprising:
identifying driving data that is collected before start of the service in response to a request of the start of the service;
comparing the driving data identified in the identifying and driving data that is collected after the request of the start of the service; and
outputting variations in a driving state before and after the start of the service.

8. A service providing method that is associated with a service of informing a driver currently driving of information related to a point where hard braking is apt to happen, according to a start request of the service, the method comprising:
updating sequentially the point where hard braking is apt to happen;
informing about the point to the driver driving at a position corresponding to the point updated sequentially;
performing comparison among driving data that are collected at different points of time after start of the service; and
outputting variations in a driving state influenced by changes in the point by the updating.

9. An apparatus that measures an effectiveness, the apparatus comprising:
a unit that compares first driving data and second driving data, and outputs a comparison result, the first driving data acquired when an alarm is issued for a driver driving at a certain point on a road, the second driving data acquired when the alarm is not issued for the driver; and
a unit that outputs a comparison result.

10. A presentation apparatus comprising:
a unit that presents an effectiveness of introducing a service of informing a driver during driving of information related to a point where hard braking is apt to happen, by comparing driving data when the service is provided and driving data when the service is not provided, and outputting a comparison result.

11. A service providing apparatus that executes a service providing method that is associated with a service of informing a driver currently driving of information related to a point where hard braking is apt to happen, according to a start request, the apparatus comprising:
a first unit configured to identify driving data that is collected before start of the service in response to a request of the start of the service,
a second unit configured to compare the driving data identified by the first unit and driving data that is collected after the request of the start of the service, and
a third unit configured to output variations in a driving state before and after the start of the service.

12. A service providing apparatus that executes a service providing method that is associated with a service of informing a driver currently driving of information related to a point where hard braking is apt to happen, according to a start request of the service, the apparatus comprising:
a first unit configured to sequentially update the point where hard braking is apt to happen,
a second unit configured to inform about the point to the driver driving at a position corresponding to the point updated sequentially, and
a third unit configured to perform comparison among driving data that are collected at different points of time after start of the service; and
a fourth unit configured to output variations in a driving state influenced by changes in the point updated by the first unit.

13. A non-transitory computer-readable recording medium having stored therein a presentation program of presenting an effectiveness of introducing a service of informing a driver during driving of information related to a point where hard braking is apt to happen, the program causing a computer to execute a process comprising:
comparing driving data when the service is provided and driving data when the service is not provided; and
outputting a comparison result.

14. A non-transitory computer-readable recording medium having stored therein a service providing program that causes a computer to execute a process that is associated with a service of informing a driver currently driving of information related to a point where hard braking is apt to happen, according to a start request, the process comprising:
identifying driving data that is collected before start of the service in response to a request of the start of the service;
comparing the driving data identified by in the identifying and driving data that is collected after the request of the start of the service; and
outputting variations in a driving state before and after the start of the service.

15. A non-transitory computer-readable recording medium having stored therein a service providing program that causes a computer to execute a process that is associated with a service of informing a driver currently driving of information related to a point where hard braking is apt to happen, according to a start request of the service, the process comprising:
updating sequentially the point where hard braking is apt to happen;
informing about the point to the driver driving at a position corresponding to the point updated sequentially; and
performing comparison among driving data that are collected at different points of time after start of the service; and
outputting variations in a driving state influenced by changes in the point in the updating.
